(19) United States
(12) Patent Application Publication
(10) Pub. No.: US 2026/0024257 A1
(43) Pub. Date: Jan. 22, 2026

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventors: KAZUYA OGASAWARA, Kanagawa (JP); KOUTA MURASAWA, Kanagawa (JP); TAKAYUKI YAMADA, Kanagawa (JP); FUMINO MATSUI, Kanagawa (JP); SHINJIRO HORI, Kanagawa (JP)

(21) Appl. No.: 19/273,335

(22) Filed: Jul. 18, 2025

(30) Foreign Application Priority Data
Jul. 18, 2024 (JP) 2024-115079

(51) Int. Cl. G06T 11/60

(52) U.S. Cl. CPC G06T 11/60; G06T 2200/24

(57) ABSTRACT

The present disclosure is an information processing apparatus configured to generate data of a creation product, and includes: a reception unit configured to receive designation of a target impression by a user, the target impression being an impression that is required to be eventually given by the creation product; and a determination unit configured to determine a prompt that causes a generative AI to generate a content to be arranged in the creation product. A first prompt determined by the determination unit in a case where the reception unit receives a first target impression is different from a second prompt determined by the determination unit in a case where the reception unit receives a second target impression different from the first target impression.

### BACKGROUND

### Field of the Technology

The present disclosure relates to an information processing apparatus, an information processing method, and a storage medium.

### Description of the Related Art

As a method of creating design data of a poster by using an information processing apparatus such as a PC or a smartphone, there is a method of using a template in which shapes and arrangement of images, characters, graphics, and the like to be arranged in the poster are determined advance. Moreover, Japanese Patent Laid-Open No. 2024-004399 (Patent Literature 1) discloses an application program that automatically generates a design of a poster. In this application program, in the case where a user designates an image and characters (hereinafter, collectively referred also to as “contents”) and an impression (target impression) of a poster desired to be created, poster data in which these contents are arranged and that has a design matching the target impression is generated.

### SUMMARY

The present disclosure is an information processing apparatus configured to generate data of a creation product, and includes: a reception unit configured to receive designation of a target impression by a user, the target impression being an impression that is required to be eventually given by the creation product; and a determination unit configured to determine a prompt that causes a generative AI to generate a content to be arranged in the creation product. A first prompt determined by the determination unit in a case where the reception unit receives a first target impression is different from a second prompt determined by the determination unit in a case where the reception unit receives a second target impression different from the first target impression.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a hardware configuration of a poster generation apparatus;

FIG. 2 is a software block diagram of a poster creation application;

FIG. 3 is a software block diagram of an image generation component;

FIG. 4A is a diagram explaining a skeleton;

FIG. 4B is a diagram illustrating an example of metadata;

FIG. 5 is a diagram explaining color scheme patterns;

FIG. 6A is a diagram illustrating a generation condition setting screen and a content setting screen provided by the poster creation application;

FIG. 6B is a diagram illustrating the content setting screen;

FIG. 7 is a diagram illustrating an image designation screen provided by the poster creation application;

FIG. 8A is a diagram illustrating an example of a prompt selection screen that is provided by the poster creation application and that is displayed on a display in the case where a prompt is changed;

FIG. 8B is a diagram illustrating the prompt selection screen provided by the poster creation application, and is an example of the case where there is one type of changed prompt;

FIG. 9 is a diagram illustrating an image selection screen provided by the poster creation application;

FIG. 10 is a diagram illustrating a preview screen provided by the poster creation application;

FIG. 11 is a flowchart illustrating a poster impression quantification process;

FIG. 12 is a diagram explaining a subjective evaluation of the poster;

FIG. 13A is a flowchart that illustrates a content impression quantification process and that explains an image impression quantification process;

FIG. 13B is a flowchart that illustrates the content impression quantification process and that explains a text impression quantification process;

FIG. 14A is a flowchart illustrating a poster generation process;

FIG. 14B is a flowchart of a condition determination process executed in S1407;

FIG. 15 is a flowchart illustrating an image generation process in a first embodiment;

FIG. 16 is a diagram illustrating a prompt impression table;

FIG. 17 is a flowchart illustrating a prompt change process;

FIG. 18A is a diagram that explains a skeleton selection method and that illustrates an example of a table in which skeletons are associated with impressions;

FIG. 18B illustrates distances in the case where a target impression is “premium feel +1, affinity −1, liveliness −2, and substantial feel +2”;

FIG. 18C illustrates examples of skeletons corresponding to Skeleton 1 to Skeleton 4 in FIG. 18A;

FIG. 19A is a diagram that explains a color scheme pattern selection method and that illustrates an example of a color scheme pattern impression table;

FIG. 19B is a diagram that explains a font selection method and that illustrates an example of a font impression table;

FIG. 20 is a software block diagram explaining a layout component in detail;

FIG. 21 is a flowchart illustrating a layout process;

FIG. 22A is a diagram explaining input of the layout component;

FIG. 22B is a diagram explaining the input of the layout component, and is an example of a table illustrating the color scheme patterns obtained from a color scheme pattern selection component;

FIG. 22C is a diagram explaining the input of the layout component, and is an example of a table illustrating fonts obtained from a font selection component;

FIG. 23A is a diagram that explains an operation of the layout component and that illustrates an example of the skeleton;

FIG. 23B is a diagram that explains the operation of the layout component and that illustrates a state of the skeleton after execution of a color scheme assigning process;

FIG. 23C is a diagram that explains the operation of the layout component and that illustrates an example of the skeleton after a process by a text arranging component;

FIG. 24 is a flowchart illustrating a poster generation process according to a modified example of the first embodiment;

FIG. 25 is a software block diagram of the poster creation application in a second embodiment;

FIG. 26 is a software block diagram explaining an image conversion component of the second embodiment in detail;

FIG. 27A is a diagram illustrating the generation condition setting screen and the content setting screen in the second embodiment;

FIG. 27B is a diagram illustrating the content setting screen;

FIG. 28 is a diagram illustrating the image designation screen in the second embodiment;

FIG. 29 is a diagram illustrating the image selection screen in the second embodiment;

FIG. 30 is a flowchart illustrating the image generation process executed in the second embodiment;

FIG. 31A is a flowchart illustrating an image conversion process executed in the second embodiment;

FIG. 31B is a flowchart explaining a prompt obtaining process in S3102;

FIG. 31C is a flowchart explaining the prompt obtaining process in S3102;

FIG. 31D is a flowchart explaining the prompt obtaining process in S3102;

FIG. 32A is a prompt input screen in the second embodiment;

FIG. 32B is a content setting screen including a prompt box;

FIG. 33 is a flowchart of the image conversion process in a modified example of the second embodiment;

FIG. 34 is a software block diagram of the poster creation application in a third embodiment;

FIG. 35 is a setting screen provided by the poster creation application of the third embodiment;

FIG. 36 is a diagram illustrating the image designation screen in the third embodiment;

FIG. 37 is a diagram illustrating a poster preview screen of the third embodiment; and

FIG. 38 is a flowchart illustrating the poster generation process in the third embodiment.

### DESCRIPTION OF THE EMBODIMENTS

Patent Literature 1 described above describes an example in which a user selects a file saved in a storage device from a dialog screen, as a method of designating an image to be used in a poster. However, there is a case where the user does not have a content desired to be used in a poster and designation of an image is difficult.

The present disclosure is directed to improve usability for obtaining a content to be arranged in a creation product such as a poster in an information processing apparatus configured to generate data of the creation product.

Embodiments of the present disclosure are explained below in detail with reference to the attached drawings. Note that the following embodiments do not limit the scope of claims, and not all of combinations of features explained in the present embodiments are necessarily essential for the present disclosure. Note that identical components are denoted by identical reference numerals, and explanation thereof is omitted.

### First Embodiment

In each of the embodiments illustrated below, explanation is given by using, as an example, a method in which an application for poster creation is operated in an information processing apparatus to generate automatically-designed poster data. The poster creation application of the present embodiment obtains a content to be used in a poster by using a generative artificial intelligence (AI). For example, in the case where an image generated by an image generative AI is used, the user needs to designate a text prompt (hereinafter, referred to as prompt) to be inputted into the image generative AI. Moreover, the user further needs to visually check whether an intended image is generated and manually perform feedback as necessarily. Accordingly, the user needs to seek out an image by repeatedly designating a prompt and checking a generated image. Accordingly, the poster creation application of the first embodiment determines a prompt that causes the generative AI to generate the content to be arranged in the creation product, based on a target impression designated by the user. This facilitates obtaining of an intended content and reduces the number of times of trial in the prompt designation. In the following embodiments, explanation is given of the case where the content generated by the generative AI is an image. Note that the content is not limited to the image, and the process described in the following embodiments may also be applied to the case where character information to be arranged in the poster is generated by a generative AI.

Note that, in the following explanation, “image” includes a still image and a frame image cut out from a video unless otherwise noted. Moreover, although explanation is given by using a poster as an example of the creation product in the following embodiments, the creation product is not limited to a poster. The embodiments can be used for any creation product that includes at least one of an image content and a text content such as a flyer, a menu, a banner, a calendar, a photocollage, a commendation, a security, a business card, a shop card, a post card, an invitation, a membership card, and the like. Moreover, these creation products may be used by being printed as well as used as electronic contents in a web site, an SNS, a virtual space, and the like.

### <System Configuration>

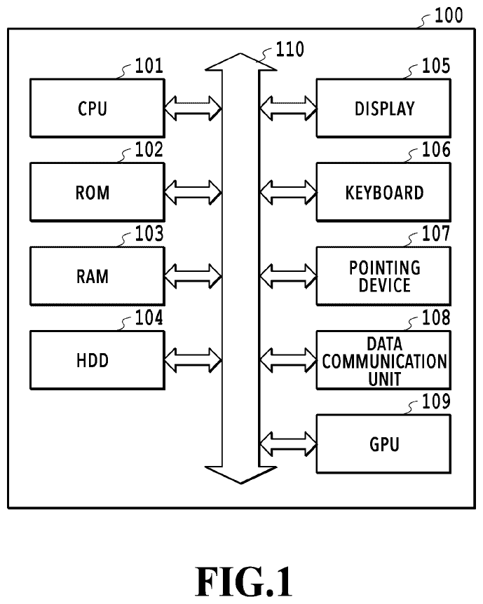

FIG. 1 is a block diagram illustrating a hardware configuration of the poster generation apparatus. Note that the poster generation apparatus 100 is an information processing apparatus, and a personal computer (hereinafter, referred to as PC), a smartphone, or the like can be given as an example. In the present embodiment, explanation is given assuming that the poster generation apparatus is a PC. The poster generation apparatus 100 includes a CPU 101, a ROM 102, a RAM 103, an HDD 104, a display 105, a keyboard 106, a pointing device 107, a data communication unit 108, and a GPU 109.

The CPU (central processing unit/processor) 101 integrally controls the poster generation apparatus 100, and implements operations of the present embodiment by, for example, reading out programs stored in the ROM 102 to the RAM 103 and executing the programs. Although there is one CPU in FIG. 1, multiple CPUs may be provided.

The ROM 102 is a general-purpose ROM, and, for example, programs to be executed by the CPU 101 are stored in the ROM 102. The RAM 103 is a general-purpose RAM, and is used as, for example, a working memory for temporarily storing various pieces of information in execution of the programs by the CPU 101.

The HDD (hard disk) 104 is a storage medium (storage unit) for storing an image file, a database holding processing results of image analysis and the like, a skeleton to be used by the poster creation application, and the like.

The display 105 is a display unit that displays a user interface (UI) of the present embodiment and displays an electronic poster as a layout result of image data (hereinafter, also referred to as “image”) to the user. The keyboard 106 and the pointing device 107 receive instruction operations from the user. The display 105 may have a touch sensor function.

For example, the keyboard 106 is used in the case where the user inputs a prompt into a generative AI and character information such as a title or the like of the poster desired to be created on the UI displayed on the display 105.

For example, the pointing device 107 is used in the case where the user clicks a button on the UI displayed on the display 105.

The data communication unit 108 communicates with an external apparatus via a wired network, a wireless network, or the like. For example, the data communication unit 108 transmits data subjected to layout by an automatic layout function, to a printer or a server capable of communicating with the poster generation apparatus 100.

The GPU 109 is a processor that performs an image process by receiving a command from the CPU 101. For example, the GPU 109 generates a poster image by analyzing images to be arranged in the poster, estimating impressions of images or texts, estimating an impression of the poster, and executing color scheme assignment and layout of images, texts, and the like on a skeleton.

A data bus 110 communicably connects the blocks of FIG. 1 to one another. Note that the configuration illustrated in FIG. 1 is merely an example, and the present disclosure is not limited to this. For example, the poster generation apparatus 100 may include no display 105, and display the UI on an external display.

The poster creation application in the present embodiment is saved in the HDD 104. The poster creation application is activated in the case where the user executes an operation such as a click or a double click on an icon of the application displayed on the display 105 with the pointing device 107.

### <Software Block Diagram>

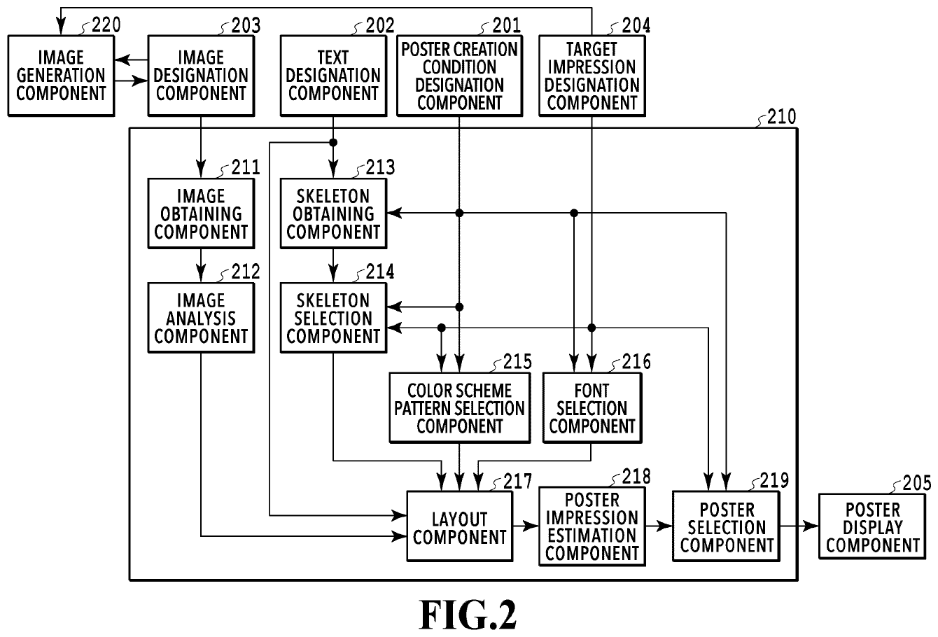

FIG. 2 is an example of a software block diagram of the poster creation application. The poster creation application includes a poster creation condition designation component 201, a text designation component 202, an image designation component 203, a target impression designation component 204, a poster display component 205, an image generation component 220, and a poster generation component 210. The poster generation component 210 includes an image obtaining component 211, an image analysis component 212, a skeleton obtaining component 213, a skeleton selection component 214, a color scheme pattern selection component 215, a font selection component 216, a layout component 217, a poster impression estimation component 218, and a poster selection component 219. FIG. 2 particularly illustrates a software block diagram relating to the poster generation component 210 that executes an automatic poster creation function.

In the case where the poster creation application is installed into the poster generation apparatus 100, an activation icon is displayed on a top screen (desktop) of an operating system (OS) operating on the poster generation apparatus 100. In the case where the activation icon is operated (for example, double-click operation) with the pointing device 107, the program of the poster creation application saved in the HDD 104 is loaded onto the RAM 103, and is executed by the CPU 101. The poster creation application is thereby activated.

Program modules corresponding to the respective components illustrated in FIG. 2 are included in the above-mentioned poster creation application. The CPU 101 executes each of the program modules to function as a corresponding one of the components illustrated in FIG. 2. Hereinafter, as explanation of the components illustrated in FIG. 2, the components are explained to execute various processes.

The poster creation condition designation component 201 designates poster creation conditions depending on a UI operation with the pointing device 107, for the poster generation component 210. In the present embodiment, the size, a creation number, and a use application category of the poster are designated as the poster creation conditions. Actual dimensional values of width and height or a sheet size such as A1 or A2 may be designated as the size of the poster. The use application category is a category indicating a use application in which the poster is to be used, and is, for example, restaurant, school event, sale, awareness building, and the like. The creation conditions designated in the poster creation condition designation component 201 are inputted into the skeleton obtaining component 213, the skeleton selection component 214, the color scheme pattern selection component 215, the font selection component 216, and the poster selection component 219.

The text designation component 202 receives designation of character information to be arranged in the poster, the designation performed by the user by performing a UI operation with the keyboard 106. The character information to be arranged in the poster represents, for example, character strings representing a title, time, date, location, and the like. Moreover, the text designation component 202 associates each piece of character information with information (tag or attribute information) indicating the type of the character information such as information indicating whether the character information is information indicating a title or information indicating time, date, and location, and then outputs the character information to the skeleton obtaining component 213 and the layout component 217.

The image designation component 203 receives designation, by the user, of one or multiple pieces of image data to be arranged in the poster. For example, the designation of image data can be performed on the image data saved in the HDD 104, based on a structure of a file system including the image data such as a device or a directory. Moreover, the designation of image data may also be performed based on attribute information or additional information for identifying an image such as shooting date/time. Furthermore, the image designation component 203 may designate image data (hereinafter, also referred to as “application material image”) included in the poster creation application and provided as a material. Moreover, the image designation component 203 may designate image data (hereinafter, also referred to as “cooperation material image”) included in an external image providing service cooperating with the poster creation application. Furthermore, the image designation component 203 may designate image data (hereinafter, also referred to as “AI generated image”) generated by an image generative AI. A generative AI is a machine learning model that generates new data based on trained data, and the image generative AI is a generative AI that generates an image. Specifically, the image generative AI is an AI that can generate an image from a text or an image by using a diffusion model, a GAN model, or the like. The image designation component 203 outputs file paths of the designated image and the generated image obtained from the image generation component 220 to the image obtaining component 211. Moreover, the image designation component 203 receives designation, by the user, of a prompt to be inputted into the image generative AI, and outputs the prompt to the image generation component 220.

The target impression designation component 204 receives designation, by the user, of the target impression of the poster to be created. The target impression is an impression that is required to be eventually given by the poster to be created and that is set to be given to a person viewing the created poster (creation product). In the present embodiment, for each of words or combinations of words representing the impression, a UI operation with the pointing device 107 is performed to designate an intensity indicating how much the poster is to give this impression. Information indicating the target impression designated in the target impression designation component 204 is shared with the skeleton selection component 214, the color scheme pattern selection component 215, the font selection component 216, the poster selection component 219, and the image generation component 220. Details of impressions are described later.

The image generation component 220 obtains the prompt from the image designation component 203, and obtains the target impression from the target impression designation component 204. The image generation component 220 generates an image to be used in the poster by using the obtained prompt and the image generative AI, and saves the image that has been generated (hereinafter, also referred to as generated image) in the HDD 104. Note that the image generative AI may be configured to be included in the poster creation application. Alternatively, the configuration may be such that the poster creation application includes no image generative AI, and uses an external image generative AI service via the data communication unit 108. In the case where the external image generative AI service is used, the image generation component 220 transmits the prompt obtained from the image designation component 203 to the external image generative AI service, and receives the generated image generated in the image generative AI service to obtain the image to be used in the poster. The image generation component 220 outputs a file path of the generated image to the image designation component 203.

The image generation component 220 determines the prompt to be inputted into the image generative AI to cause the image generative AI to generate the image to be arranged in the poster. Specifically, the image generation component 220 determines the prompt depending on the target impression designated by the user. Specifically, in the case where the target impression varies, the result is such that the determined prompt also varies. A first prompt determined in the case where a first target impression is received from the target impression designation component 204 is different from a second prompt determined in the case where a second target impression different from the first target impression is received from the target impression designation component 204.

In the first embodiment, in the case where the image generation component 220 obtains a prompt designated by the user from the image designation component 203, the image generation component 220 determines the prompt to be inputted into the image generative AI by changing the prompt obtained from the image designation component 203. The image generation component 220 changes the prompt obtained from the image designation component 203 such that an impression estimated from the prompt after the change is closer to the target impression than an impression estimated from the prompt before the change is. In the case where the image generation component 220 obtains the first target impression, the image generation component 220 changes the prompt obtained from the image designation component 203 to the first prompt. Meanwhile, in the case where the image generation component 220 obtains the second target impression different from the first target impression, the image generation component 220 changes the prompt obtained from the image designation component 203 to the second prompt.

More specifically, the image generation component 220 changes the prompt obtained from the image designation component 203 to the above-mentioned first prompt or the above-mentioned second prompt, based on a difference between the target impression obtained from the target impression designation component 204 and the impression of the obtained prompt.

Moreover, the image generation component 220 may determine the prompt to be inputted into the generative AI based on the target impression and an impression estimated from an image. The image may be an image designated by the user in the image designation component 203 or an image generated by the image generative AI by using the prompt obtained from the image designation component 203 or the prompt after the change. The image generation component 220 determines a prompt close to the target impression based on a difference between the target impression and the impression estimated from the image. In the case where the prompt is determined based on the target impression and the impression estimated from the image generated by the image generative AI, the image generation component 220 determines the prompt close to the target impression by changing the prompt used for the generation of the image.

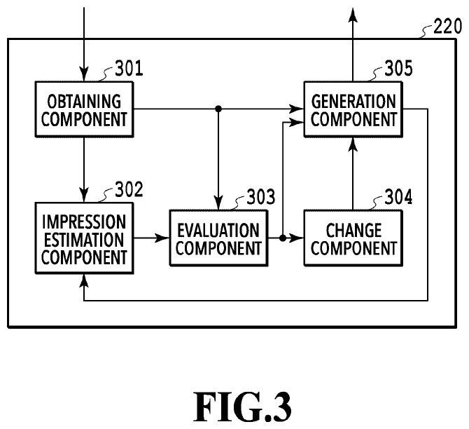

FIG. 3 is a software block diagram of the image generation component 220. As illustrated in FIG. 3, the image generation component 220 includes an obtaining component 301, an impression estimation component 302, an evaluation component 303, a change component 304, and a generation component 305. FIG. 3 illustrates software blocks for a function of changing the prompt obtained by the image generation component 220 based on the target impression.

The obtaining component 301 obtains the prompt designated in the image designation component 203, prompt change permission information set in the image designation component 203, and the target impression designated in the target impression designation component 204. The obtaining component 301 records the obtained prompt in the RAM 103. This is performed to use the obtained prompt as a base prompt to be described later. The prompt change permission information is information indicating an instruction given by the user on whether to permit changing of the prompt or not. The obtaining component 301 switches an operation depending on the content of the obtained prompt change permission information. Specifically, in the case where the obtaining component 301 obtains the prompt change permission information indicating permission of the changing of the prompt, the change component 304 changes the prompt as necessary, and the generation component 305 generates an image by using the prompt after the change (hereinafter, referred to as changed prompt). In the case where the obtaining component 301 does not obtain the prompt change permission information indicating permission of the changing of the prompt, the change component 304 does not change the prompt, and the generation component 305 executes an image generation process using the prompt obtained by the obtaining component 301.

The impression estimation component 302 estimates the impression of the prompt obtained by the obtaining component 301. The prompt impression estimation can be performed by using a machine learning model for text impression estimation generated in a text impression quantification process to be descried later.

Moreover, the impression estimation component 302 estimates the impression of the image (generated image) generated by the generation component 305. The image impression estimation can be performed by using a machine learning model for image impression estimation generated in an image impression quantification process to be described later. Note that, in the case where the generation component 305 performs the image generation multiple times, the impression estimation is performed for each of images generated in the image generation performed multiple times.

The evaluation component 303 determines a difference (hereinafter, also referred to as impression difference) and a distance between the target impression obtained by the obtaining component 301 and the impression of the prompt estimated by the impression estimation component 302. The determined impression difference represents a change amount necessary for changing the impression of the prompt to an impression close to the target impression. In the present embodiment, a Euclidean distance is used as the distance (hereinafter, mere distance means Euclidean distance). The smaller the value indicated by the distance is, the closer the impression estimated from the prompt is to the target impression. Furthermore, the distance determined by the evaluation component 303 is not limited to the Euclidean distance, and may be a Manhattan distance, a Cosine similarity, or the like as long as a distance between vectors can be determined. The evaluation component 303 determines whether the determined distance is larger than a predetermined threshold or not. In the case where the distance determined by the evaluation component 303 is larger than the predetermined threshold, the evaluation component 303 instructs the change component 304 to change the prompt. In the case where the distance determined by the evaluation component 303 is not larger than the predetermined threshold, the evaluation component 303 does not give the instruction to change the prompt.

Moreover, the evaluation component 303 determines a difference and a distance between the target impression obtained by the obtaining component 301 and an impression of the generated image estimated by the impression estimation component 302, and associates the difference and the distance with the corresponding image. The determined impression difference represents a change amount necessary for changing the impression of the generated image to the target impression. Moreover, the smaller the value indicated by the distance is, the closer the impression of the generated image is to the target impression. The evaluation component 303 determines whether all of the distances determined, respectively, for all generated images are larger than a predetermined threshold or not. In a situation where all distances are larger than the predetermined threshold, that is in a situation where no image suiting the target impression is generated even in the case where the prompt is changed multiple times, the evaluation component 303 displays, for example, a warning screen indicating that prompt change suiting the target impression is difficult, on the display 105. Then, the image generation process may be cancelled. Alternatively, the evaluation component 303 may hold and obtain top N generated images in ascending order of the distance generated up to this time point.

The change component 304 changes the prompt obtained by the obtaining component 301 to a prompt suiting the target impression, based on the result of the evaluation by the evaluation component 303. The change component 304 determines the changed prompt such that a value indicating a distance between the target impression and the impression estimated from the prompt (changed prompt) changed by the change component 304 becomes smaller than a predetermined threshold.

The changed prompt determined by the change component 304 includes for example, the base prompt that is a prompt to be used as a base and one or multiple additional prompts added to the base prompt. The change component 304 determines each additional prompt, based on a difference between the target impression and an impression estimated from the base prompt. In the present embodiment, the additional prompt can be obtained from a prompt impression table (impression information) held in advance in the HDD 104. The prompt impression table is information in which character strings (additional prompts) and values indicating impressions of the character strings (additional prompts) are associated with one another in advance. The change component 304 obtains a character string (additional prompt) for which a distance between the impression of the additional prompt and the difference between the target impression and the impression estimated from the base prompt is smaller than a predetermined threshold, from the prompt impression table.

In the determination of the changed prompt, the change component 304 selects a prompt to be used for generation of a content from one or multiple changed prompts. Moreover, in this case, the change component 304 may display a screen for selecting the prompt to be used for the generation of a content from one or multiple changed prompts, and receive selection by the user. The screen for selecting the prompt is described later.

The generation component 305 obtains the prompt obtained by the obtaining component 301 or the changed prompt from the change component 304, generates a random number as an initial value to be inputted into the image generative AI, inputs the obtained prompt and the generated random number into the image generative AI, and generates an image. Note that the image generative AI can use a known technique for generating an image from a prompt. In the present embodiment, Stable Diffusion is assumed to be used as the image generative AI. Note that other known image generative AIs including Midjourney (https://www.midjourney.com/home/) may be used, and image generative AIs to be developed in the future may be used. Any technique may be used as long as it is a technique that can generate an image according to contents of an inputted prompt. Note that, in the case where there are multiple prompts obtained by the generation component 305, the generation component 305 performs the image generation for each of the obtained prompts, and multiple generated images are obtained.

Moreover, the generation component 305 selects an image to be actually used in the poster from the generated images. Specifically, the generative AI generates an image by using each of the one or multiple changed prompts determined (changed) by the change component 304, and selects the generated image to be arranged in the poster from the one or multiple generated images. In this case, the generation component 305 may display a screen for selecting the generated image to be arranged in the poster from the one or multiple generated images, and receive selection by the user. The screen for selecting the image is described later.

Returning to explanation of FIG. 2, next, a software configuration of the poster generation component 210 is explained in detail.

The image obtaining component 211 obtains the one or multiple pieces of image data designated by the user in the image designation component 203, from the designated obtaining destination. The image obtaining component 211 outputs the obtained image data to the image analysis component 212. The obtaining destination of the images includes the HDD 104, a storage region on the network, and the like. Moreover, the obtained images include still images, frame images cut out from a video, material images created in advance for the present application, material images provided by an image providing service, images generated by a generative AI, and the like. The still images and the frame images are images obtained from an imaging device such as a digital camera or a smart device. The imaging device may be included in the poster generation apparatus 100 or an external apparatus. Note that, in the case where the imaging device is the external device, the images are obtained via the data communication unit 108. Moreover, as another example, the still images may be illustration images created with image editing software or CG images created with CG creating software. The still images and cut-out images may be images obtained from a network or a server via the data communication unit 108. The images obtained from the network or the server include social networking service images (hereinafter, referred to as “SNS images”), material images, images provided outside the poster generation apparatus 100, and images generated by using an image generative AI. Moreover, a program executed by the CPU 101 analyzes data attached to each image and determines a saving source for the image. For example, the obtaining destination of the SNS images may be managed in an application by obtaining the images from an SNS via the application. Note that the images are not limited to the images described above, and may be other types of images.

The image analysis component 212 executes an image data analysis process on the image data obtained from the image obtaining component 211, and obtains information indicating image feature amounts. Specifically, the image analysis component 212 executes an object recognition process to be described later, and obtains the feature amounts of the image data. Moreover, the image analysis component 212 associates information indicating the obtained feature amounts with the image data, and outputs the image data to the layout component 217.

The skeleton obtaining component 213 obtains one or multiple skeletons matching the conditions designated in the poster creation condition designation component 201, the text designation component 202, and the image obtaining component 211, from the HDD 104. In the present embodiment, skeletons are each information indicating arrangement of contents (character strings and images), graphics, and the like to be arranged in the poster.

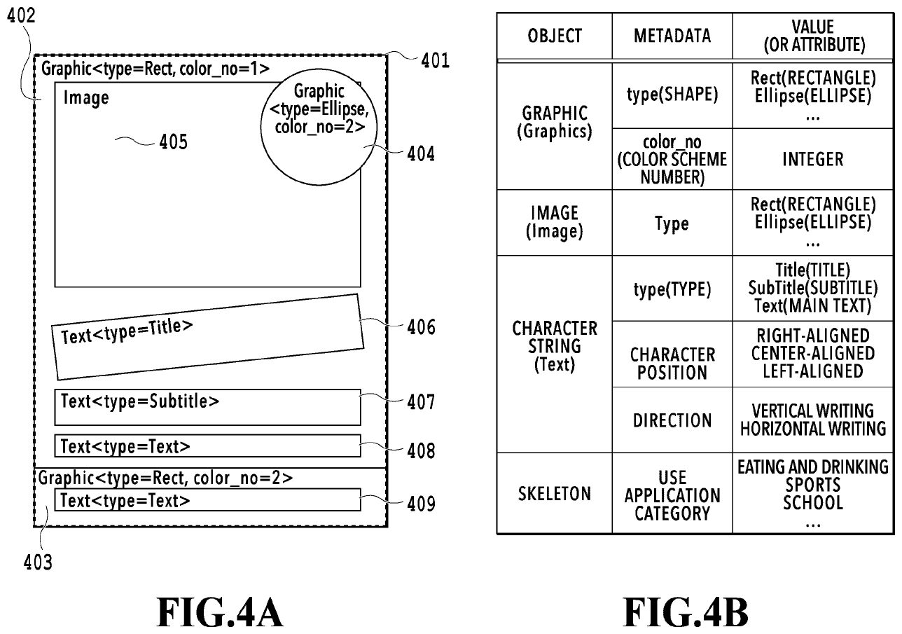

FIGS. 4A and 4B are diagrams illustrating an example of the skeleton. Three graphical objects 402, 403, and 404, one image object 405, and four text objects 406, 407, 408, and 409 that are objects in which characters are to be arranged are arranged on a skeleton 401 of FIG. 4A. In each object, a position indicating a location where the object is arranged, the size and angle of the object, and metadata necessary for generation of the poster are recorded. FIG. 4B is a diagram illustrating an example of the metadata. For example, which type of character information is to be arranged is held in each of the text objects 406 to 409 as an attribute of the metadata. In this example, it is illustrated that a title is to be arranged in the text object 406, a subtitle is to be arranged in the text object 407, and main texts are to be arranged in the text objects 408 and 409. Moreover, a shape of a graphic and a color scheme number (color scheme ID) indicating a color scheme pattern are held in each of the graphical objects 402 to 404 as the attribute of the metadata. In this example, it is illustrated that the attributes of the graphical objects 402 and 403 are rectangle and the attribute of the graphical object 404 is ellipse. Moreover, a color scheme number 1 is assumed to be assigned to the graphical object 402, and a color scheme number 2 is assumed to be assigned to the graphical objects 403 and 404. In this example, it is illustrated that the color scheme number is information referred to in color scheme application to be described later, and different colors are assigned to different color scheme numbers. Note that the types of objects and the metadata are not limited to those described above. For example, a map object for arranging a map or a barcode object for arranging a QR code (registered trademark) or a barcode may be provided. Moreover, metadata indicating a space between lines and a space between characters may be provided as the metadata of the text object. The configuration may be such that the metadata includes a use application of the skeleton, and the use application is used for control of allowing or not allowing use of the skeleton depending on use application.

For example, the skeleton may be saved in the HDD 104 in a CSV format or in a DB format such as SQL. The skeleton obtaining component 213 outputs the one or multiple skeletons obtained from the HDD 104, to the skeleton selection component 214.

The skeleton selection component 214 selects one or multiple skeletons matching the target impression designated in the target impression designation component 204 among the skeletons obtained from the skeleton obtaining component 213, and outputs the selected skeletons to the layout component 217. Since the arrangement of the entire poster is determined by the skeleton, preparing various types of skeletons in advance can increase variety of generated posters.

The color scheme pattern selection component 215 obtains one or multiple color scheme patterns matching the target impression designated in the target impression designation component 204, from the HDD 104, and outputs the obtained color scheme patterns to the layout component 217. The color scheme patterns are each a combination of colors to be used in the poster.

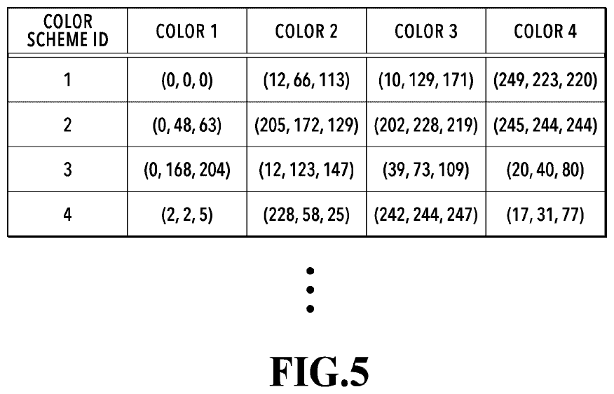

FIG. 5 is a diagram illustrating an example of a table of the color scheme patterns. In the present embodiment, each color scheme pattern is illustrated as a combination of four colors. The column of color scheme ID in FIG. 5 is an ID for uniquely identifying the color scheme pattern. Columns of color 1 to color 4 each illustrate a color value of each of R, G, and B in a value of 0 to 255 in the order of RGB ((R, G, B)=(0 to 255, 0 to 255, 0 to 255)). Although the color scheme pattern formed of the combination of four colors is used in the present embodiment, the number of colors may be another number, or multiple numbers of colors may coexist.

The font selection component 216 selects one or multiple font patterns matching the target impression designated in the target impression designation component 204, obtains the selected font patterns from the HDD 104, and outputs the font patterns to the layout component 217. The font patterns are each a combination of at least one of a font of the title, a font of the subtitle, and a font of the main text.

The layout component 217 lays out various pieces of data on each of the one or multiple skeletons obtained from the skeleton selection component 214, and generates one or multiple pieces of poster data as many as or more than the designated poster creation number by laying out the various pieces of data. The layout component 217 arranges the text obtained from the text designation component 202 and the image data obtained from the image analysis component 212, on each skeleton. Moreover, the layout component 217 applies each color scheme pattern obtained from the color scheme pattern selection component 215, and applies each font pattern obtained from the font selection component 216. The layout component 217 outputs the generated one or multiple pieces of poster data to the poster impression estimation component 218.

The poster impression estimation component 218 estimates the impression of each of the multiple pieces of poster data obtained from the layout component 217, and associates the estimated impression with the piece of poster data. Then, the poster impression estimation component 218 outputs the one or multiple pieces of poster data associated with the estimated impression, to the poster selection component 219.

The poster selection component 219 compares the target impression designated in the target impression designation component 204 and each of the estimated impressions of the multiple pieces of poster data associated with the estimated impressions obtained from the poster impression estimation component 218, and selects the poster data associated with the estimated impression close to the target impression. The poster selection component 219 selects posters as many as or more than the creation number designated in the poster creation condition designation component 201. In this case, the poster selection component 219 selects posters as many as or more than the creation number, in ascending order of a value (distance) indicating a difference between the target impression and the estimated impression. The closeness between the target impression and the estimated impression is determined based on a distance determined from a difference of an impression value for each impression factor. The selection result is saved in the HDD 104. The poster selection component 219 outputs the selected poster data to the poster display component 205.

The poster display component 205 displays poster images based on the poster data obtained from the poster selection component 219, on the display 105. The poster images are, for example, bit map data. Note that, since the pieces of poster data as many as or more than the creation number designated in the poster creation condition designation component 201 are generated in the poster generation component 210, previews of the poster images are displayed on the display 105 as a list. In the case where the user clicks any of the poster images with the pointing device 107, the clicked poster image is set to a selected state.

Note that the poster creation application may be additionally provided with a function of further changing each poster to a design desired by the user after the display of the generation result in the poster display component 205 by editing the arrangement, the colors, the shapes, and the like of the image, the text, and the graphic by additional user operations (not illustrated). Moreover, providing a function of printing the poster data saved in the HDD 104 with a printer under a condition designated in the poster creation condition designation component 201 allows the user to obtain a print product of the created poster.

### <Example of Display Screen>

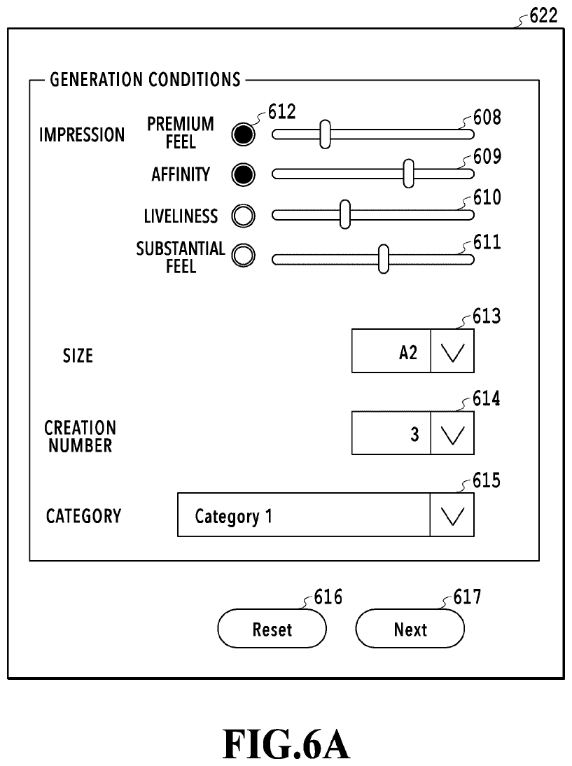

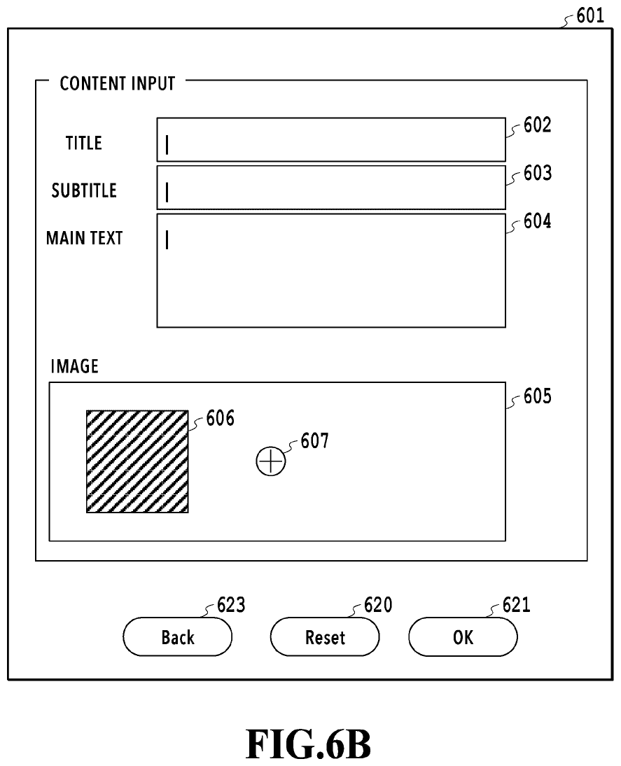

FIGS. 6A and 6B are diagrams illustrating examples of a generation condition setting screen 622 and a content setting screen 601 provided by the poster creation application. The generation condition setting screen 622 illustrated in FIG. 6A and the content setting screen 601 illustrated in FIG. 6B are displayed on the display 105. The user designates the text and the image that are the contents to be arranged in the poster, the target impression of the poster to be created, and the poster creation conditions (size, creation number, use application category) through the generation condition setting screen 622 and the content setting screen 601. The poster creation condition designation component 201, the target impression designation component 204, the image designation component 203, and the text designation component 202 obtain the designated contents from the user through these UI screens.

Impression sliders 608 to 611 of the generation condition setting screen 622 are each an operation object with which the user sets a value indicating a degree of the target impression of the poster to be created for a corresponding one of factors (hereinafter, referred to as impression factors) of the target impression. For example, the impression slider 608 is a slider for setting a value indicating a degree of the target impression for an impression factor “premium feel”. The target impression is set such that the further the impression slider 608 is slid to the right, the higher the impression of premium feel given by the poster is, and the further the impression slider 608 is slid to the left, the lower (cheaper) the impression of premium feel given by the poster is. Moreover, combining the factors of the target impression set in the respective sliders enables setting of a comprehensive target impression reflecting not only the impression factor set in one slider but also the impression factors set in the other sliders.

For example, in the case where the impression slider 608 corresponding to the impression factor “premium feel” is set on the right side of the center and the impression slider 611 corresponding to an impression factor “substantial feel” is set on the left side of the center, a poster with an elegant impression that has high premium feel and low substantial feel is generated. Moreover, for example, in the case where the impression slider 608 corresponding to the impression factor “premium feel” is set on the right side of the center and the impression slider 611 corresponding to the impression factor “substantial feel” is set on the right side of the center, a poster with a gorgeous impression that has high premium feel and high substantial feel is generated. Combining the factors of target impression indicated by the multiple impression sliders as described above enables setting of target impressions of various directions such as the “elegant” target impression and the “gorgeous” target impression even in the case where the factor “premium feel” of the target impression is commonly set to presence of “premium feel”.

Specifically, the target impression is formed of and determined by multiple factors indicating the impression. Note that the target impression may be determined by one factor indicating the impression. In the present embodiment, each of the values indicating the impression is assumed to be corrected to a value from −2 to +2 with −2 being a state where the slider set to the left-most position and +2 being a state where the slider is set to the right-most position. These numerical values are values indicating that −2 is low, −1 is slightly low, 0 is neither high nor low, +1 is slightly high, and +2 is high for the impression. Note that purpose of correcting the value to a value from −2 to +2 is to match the value with a scale of the estimated impression and facilitate distance calculation to be described later. The present disclosure is not limited to this, and normalization may be performed by using a value from 0 to 1.

Radio buttons 612 are buttons that enable execution of control of enabling or disabling setting of the respective impression factors. The user can set whether to enable or disable the setting of each impression factor by pressing a corresponding one of the radio buttons 612 and setting on/off. For example, in the case where off is selected in one of the radio buttons 612, the corresponding impression factor is excluded from the control of impression. For example, in the case where a calm poster with low liveliness is desired to be created and there is no particular designation for other impressions, the user can set the radio buttons 612 for the impression factors other than the liveliness to off to create a poster specialized in low liveliness. Note that FIGS. 6A and 6B illustrate a state where premium feel and affinity are set to on, and liveliness and substantial feel are set to off. This enables control with high flexibility in which all impression factors are used for the poster generation or only some of the impression factors are used for the poster generation. Note that, in the case where a state in which each of the sliders is set to the left-most position is considered to be the same as a state in which a corresponding one of the impression factors is not set, a configuration provided with no radio buttons 612 may be employed. In this case, in the case where the setting of each impression factor is to be disabled, the user can disable the setting of the impression factor by setting the corresponding slider to the left-most position.

A size list box 613 is a list box for setting the size of the poster to be created. The user can perform a click operation with the pointing device 107 to display a list of creatable poster sizes and select a poster size. The number of candidates of the poster to be created can be set in a creation number box 614. The use application category of the poster to be created can be set in a category list box 615.

A reset button 616 is a button for resetting the pieces of setting information on the generation condition setting screen 622. A next button 617 is a button for transitioning to the content setting screen 601 illustrated in FIG. 6B.

In the case where the user presses the next button 617, a displayed screen switches to the content setting screen 601. Moreover, the poster creation condition designation component 201 and the target impression designation component 204 output information set on the generation condition setting screen 622 to the poster generation component 210. In this case, the poster creation condition designation component 201 obtains the size of the poster to be created from the size list box 613, obtains the number of posters to be created from the creation number box 614, and obtains the use application category of the poster to be created from the category list box 615. The target impression designation component 204 obtains the target impression of the poster to be created from the impression sliders 608 to 611 and the radio buttons 612. Note that the poster creation condition designation component 201 and the target impression designation component 204 may process the values set on the generation condition setting screen 622. For example, the target impression designation component 204 may correct the values of the target impression designated in the impression sliders 608 to 611.

The title box 602, the subtitle box 603, and the main text box 604 of the content setting screen 601 receive designation, by the user, of the character information to be arranged in the poster. Note that, although three types of character information are received in the present embodiment, the present disclosure is not limited to this. For example, character information such as location, time, and date may also be additionally received. Moreover, the character information does not have to be inputted into all boxes, and there may be a blank box.

An image designation region 605 is a region in which the image to be arranged in the poster is designated and displayed. An image 606 illustrates a thumbnail of the designated image. An image addition button 607 is a button for adding the image to be arranged in the poster. In the case where the user presses the image addition button 607, the image designation component 203 displays an image designation screen 701 for selecting an image file, and receives image file selection by the user. Then, a thumbnail of the selected image is added to the image designation region 605.

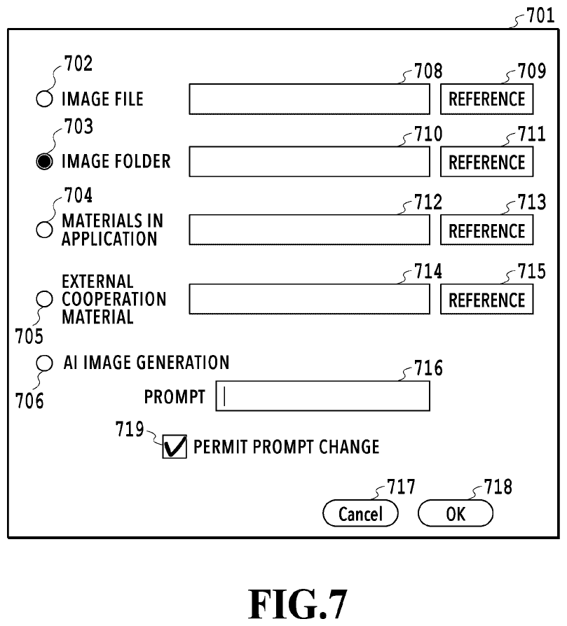

The image designation screen 701 is explained by using FIG. 7. The image designation screen 701 is displayed on the display 105. The user can designate an obtaining destination of the image to be arranged in the poster or an obtaining destination of an image folder including multiple images, through the image designation screen 701. The image designation component 203 obtains setting contents from the user through this UI screen.

Radio buttons 702 to 706 are each a button for setting a method of designating the image data to be the candidate. The user can press the radio buttons 702 to 706 to set on/off of the methods of designating the image data. Although multiple radio buttons are displayed, only one radio button can be set to on. Specifically, in the case where a radio button set to off is set to on, this radio button is set to an on state, but a radio button in the on state before the setting is automatically set to off.

The radio button 702 is a button for setting, as the method of designating the image, a method in which one or multiple pieces of image data is designated. A designation box 708 receives designation of the one or multiple pieces of image data. The user can designate each piece of image data to be a candidate by designating a file path of the image data in the designation box 708. A reference button 709 is a button for designating the one or multiple pieces of image data. In the case where the user presses the reference button 709, the image designation component 203 displays a dialog screen for selecting a file saved in the HDD 104, and receives image file selection by the user.

The radio button 703 is a button for setting, as the method of designating the image, a method in which a folder including one or multiple pieces of image data is designated as the obtaining destination of the image group. A designation box 710 receives designation of the folder including one or multiple pieces of image data. The user can designate all pieces of image data included in the folder as the image group by designating a folder path in the designation box 710. A reference button 711 is a button for designating the obtaining destination folder. In the case where the user presses the reference button 711, the image designation component 203 displays a dialog screen for selecting a folder saved in the HDD 104, and receives folder selection by the user.

The radio button 704 is a button for setting, as the method of designating the image, a method in which application material images are designated. A designation box 712 displays names of the application material images designated through a reference button 713. The reference button 713 is a button for designating one or multiple application material images. In the case where the user presses the reference button 713, the image designation component 203 displays a dialog screen for selecting the application material images, and receives image selection by the user. Note that, in the case where tag information is given to each application material image, the configuration may be such that the user can designate a tag to select the application material images to which this tag is attached in a batch.

The radio button 705 is a button for setting, as the method of designating the image, a method in which cooperation material images are designated. A designation box 714 displays names of the cooperation material images designated through a reference button 715. The reference button 715 is a button for designating one or multiple cooperation material images. In the case where the user presses the reference button 715, the image designation component 203 displays a dialog screen for selecting the cooperation material images, and receives image selection by the user. Note that, in the case where tag information is given to each cooperation material image, the configuration may be such that the user can designate a tag to select the cooperation material images to which this tag is attached in a batch.

The radio button 706 is a button for setting, as the method of designating the image, a method in which images are generated by using the image generative AI. A prompt box 716 receives designation of a prompt to be used as input of the image generative AI. Then, the image designation component 203 generates images by using the designated prompt and the image generative AI, and saves the generated images in the HDD 104. Then, the image designation component 203 designates file paths of the saved AI-generated images.

A check box 719 is a box for setting the prompt change permission information that indicates whether automatic changing of the prompt designated in the prompt box 716 in the image generation process is permitted or not. In the case where the check box 719 is checked, the image designation component 203 designates the prompt change permission information indicating that the changing of the prompt is permitted. In the case where the check box 719 is not checked, the image designation component 203 designates the prompt change permission information indicating that the changing of the prompt is not permitted.

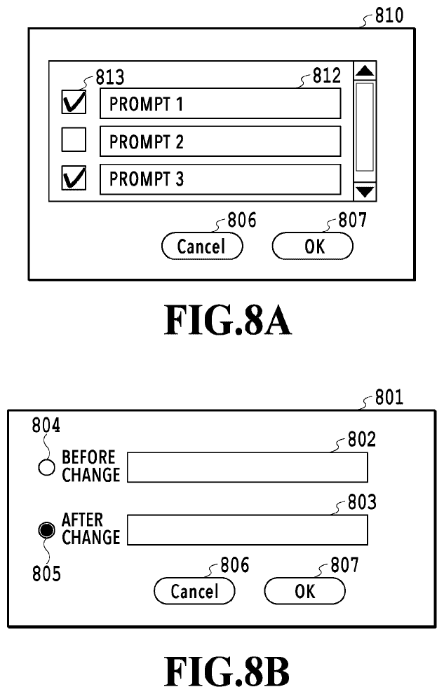

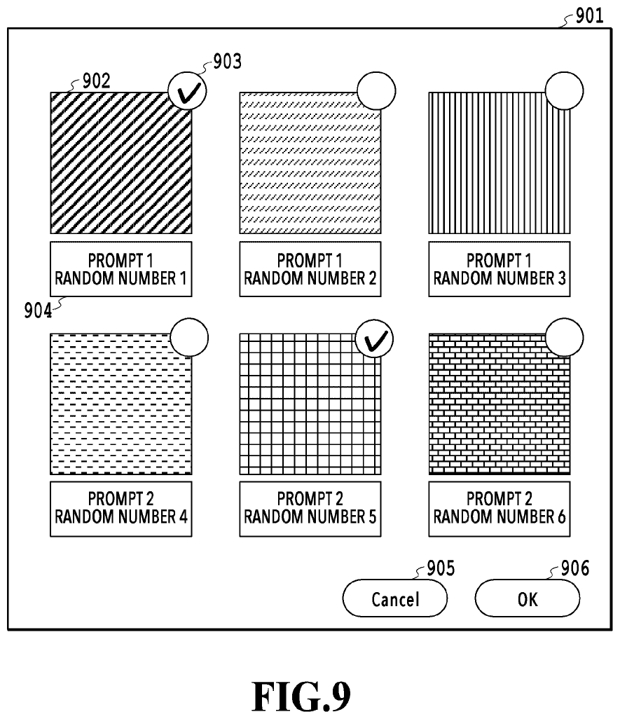

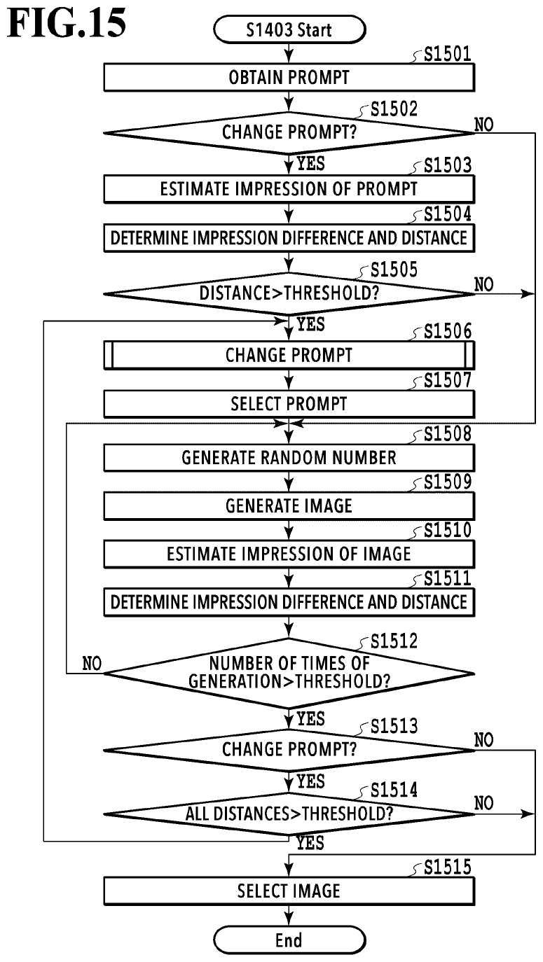

A cancel button 717 is a button for cancelling the designation of the image. In the case where the cancel button 717 is pressed, the pieces of setting information on the image designation screen 701 are ignored, and the screen displayed on the display 105 transitions to the content setting screen 601. In the case where the user presses an OK button 718, the screen displayed on the display 105 transitions to the content setting screen 601. In this case, a thumbnail of each of one or multiple images designated in the image designation screen 701 is added to the image designation region 605 of the content setting screen 601. Note that, in the case where the OK button 718 is pressed in the state where the radio button 706 indicating AI image generation on the image designation screen 701 is on, the image generation process illustrated in FIG. 15 is executed, and then the screen transitions to a prompt selection screen (FIGS. 8A and 8B) or an image selection screen (FIG. 9) to be described later.

Returning to FIG. 6B, a back button 623 is a button for cancelling the designation on the content setting screen 601 and returning to the generation condition setting screen 622. A reset button 620 is a button for resetting the pieces of setting information on the content setting screen 601.

In the case where the user presses an OK button 621, the text designation component 202 and the image designation component 203 output the contents (character information and image) set on the content setting screen 601, to the poster generation component 210. In this case, the image designation component 203 obtains the file path of the image to be arranged in the poster, from the image designation region 605. The text designation component 202 obtains the character information to be arranged in the poster from the title box 602, the subtitle box 603, and the main text box 604. Note that the text designation component 202 and the image designation component 203 may process the values set on the content setting screen 601. For example, the text designation component 202 may remove unnecessary whitespace characters at a head or an end of the inputted character information, from the character information.

FIG. 8A is a diagram illustrating an example of the prompt selection screen displayed on the display 105 in the case where the image generation component 220 changes the prompt. In the case where the OK button 718 is pressed in a state where the radio button 706 and the check box 719 are enabled on the image designation screen 701 and the prompt is changed in the image generation process, the screen displayed on the display 105 transitions to a prompt selection screen 810.

The prompt selection screen 810 is a screen displayed in the case where there are one or multiple types of prompts after the change. The user can designate one or multiple prompts for generating the image through the prompt selection screen 810.

Multiple prompts 812 changed by the change component 304 of the image generation component 220 are arranged and displayed on the prompt selection screen 810. Moreover, a check box 813 is displayed for each prompt. The user can set the prompt desired to be used to a selected state (ON) by clicking the check box 813 corresponding to this prompt with the pointing device 107. Note that multiple check boxes 813 can be set to ON. Moreover, the prompts 812 includes multiple prompts before and after the change. A cancel button 806 is a button for cancelling the selection of the prompt. In the case where the cancel button 806 is pressed, the process by the image generation component 220 is cancelled, and the screen displayed on the display 105 transitions to the image designation screen 701. In the case where the user presses an OK button 807, the process of the image generation component 220 is resumed by using the designated prompt.

Moreover, in the case where there is one type of changed prompt, the image generation component 220 may display a prompt selection screen 801 illustrated in FIG. 8B. The user can designate one prompt to be designated for the image generation through the prompt selection screen 801. A display box 802 is a box for displaying the prompt before the change inputted by the user in the prompt box 716 in the image designation screen 701 of FIG. 7. A display box 803 is a box for displaying the changed prompt changed by the image generation component 220. A radio button 804 is a button for designating the prompt displayed in the display box 802, as a prompt to be used in the image generation. A radio button 805 is a button for designating the prompt displayed in the display box 803, as the prompt to be used in the image generation.

FIG. 9 is a diagram illustrating an example of the image selection screen in which images generated by the image generation component 220 are displayed on the display 105. In the case where the OK button 807 is pressed on the prompt selection screen 801 or the prompt selection screen 810 illustrated in FIGS. 8A and 8B and the image generation is completed, the screen displayed on the display 105 transitions to an image selection screen 901.

One or multiple generated images 902 generated by the image generation component 220 are arranged and displayed on the image selection screen 901. Since one or multiple images are generated in the image generation component 220, the generated images 902 are displayed on the image selection screen 901 as a list. In the case where the user designates any of the generated images 902 with the pointing device 107, the designated generated image 902 is set to a selected state, and a check mark 903 is displayed. Note that multiple generated images 902 can be selected.

Information display areas 904 are each an area for displaying information on the image generation. In the present embodiment, the prompt and the random number used for the generation of the corresponding generated image 902 are displayed as the information on the image generation. The random number is a value inputted into the generative AI as the initial value of the generated image 902. A cancel button 905 is a button for cancelling the selection of the generated image 902. In the case where the cancel button 905 is pressed, the selection of the generated image 902 is cancelled, and the screen displayed on the display 105 transitions to the prompt selection screen 810 or the prompt selection screen 801. Note that the transition destination screen is not limited to the prompt selection screen 810 and the prompt selection screen 801, and the configuration may be such that the image generation process is cancelled and the screen transitions to the image designation screen 701. In the case where the user presses an OK button 906, the image generation component 220 saves the generated image 902 in the selected state in the HDD 104, and causes the screen displayed on the display 105 to transition to the content setting screen 601.

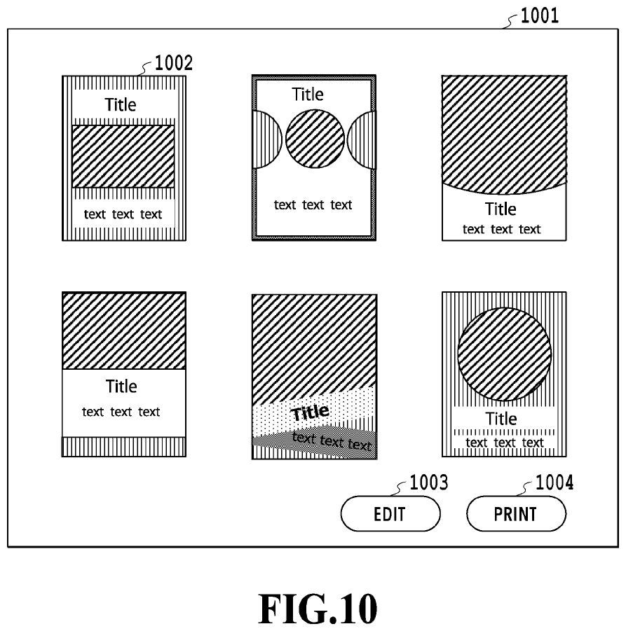

FIG. 10 is a diagram illustrating an example of a poster preview screen 1001 in which the poster display component 205 displays generated poster images 1002 on the display 105. In the case where the OK button 621 of the content setting screen 601 is pressed and the poster generation is completed, the screen displayed on the display 105 transitions to the poster preview screen 1001.

The poster images 1002 are poster images outputted by the poster display component 205. Since pieces of poster data as many as or more than the creation number designated in the poster creation condition designation component 201 are generated in the poster generation component 210, poster images 1002 as many as the number of generated pieces of poster data are displayed as a list. In the case where the user clicks one of the poster images 1002 with the pointing device 107, the poster data corresponding to the clicked poster image 1002 is set to a selected state.

An edit button 1003 is a button for transition to a function of editing the poster data set to the selected state. In the edit function, editing of the poster data can be performed through a not-illustrated UI.

A print button 1004 is a button for transition to a function of printing the poster data set to the selected state. In the print function, the poster data can be printed through a not-illustrated control UI of a printer.

### <Poster Impression Quantification>

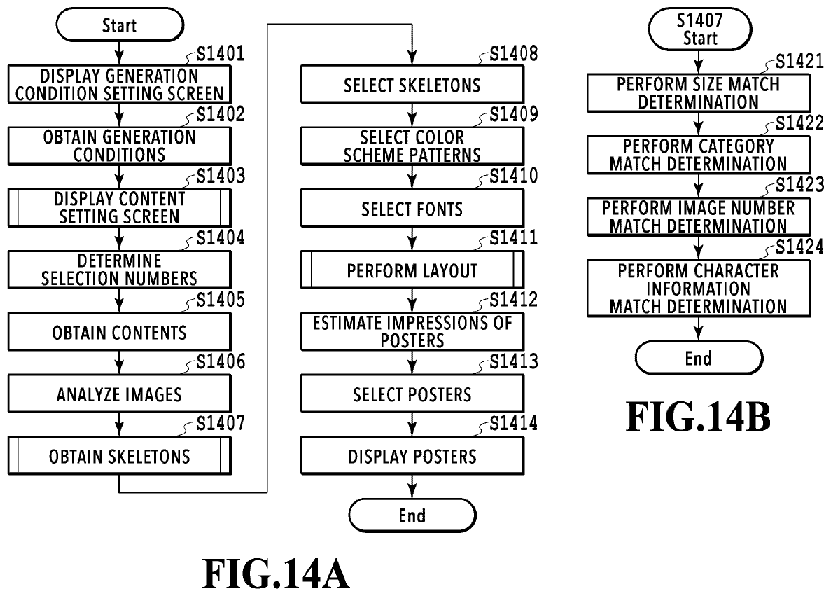

A process (hereinafter, referred to as poster impression quantification process) of quantifying the impression of each poster is explained. The poster impression quantification process is a preliminary process necessary for execution of a poster impression estimation process (S1412 of FIG. 14A) to be described later.

The poster impression quantification process is performed in a development stage of the poster creation application by a vendor or the like developing the poster creation application. Note that the poster impression quantification process may be executed in the poster generation apparatus 100 or in an information processing apparatus different from the poster generation apparatus 100. Note that, in the case where the poster impression quantification process is executed in the information processing apparatus different from the poster generation apparatus 100, the poster impression quantification process is executed by a CPU of the information processing apparatus.

In the poster impression quantification process, impressions felt by a person for various posters are quantified. Simultaneously, correspondence relationships between the poster images and the impressions of the posters are derived. This allows the impression of the poster to be estimated from the generated poster image. In the case where the estimation of the impression is possible, it is possible to control the impression of the poster by correcting the poster image or to search for the poster image giving a certain target impression. Note that the poster impression quantification process is executed by, for example, operating an impression learning application for learning the impressions of the poster images in advance in the poster generation apparatus before the poster generation process.

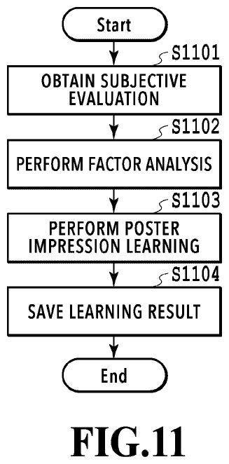

FIG. 11 is a flowchart illustrating the poster impression quantification process. For example, the CPU 101 implements the flowchart illustrated in FIG. 11 by reading out programs stored in the HDD 104 to the RAM 103 and executing the programs. The poster impression quantification process is explained with reference to FIG. 11. Note that sign “S” in explanation of each process means step in the flowchart (the same applies below in the present specification).

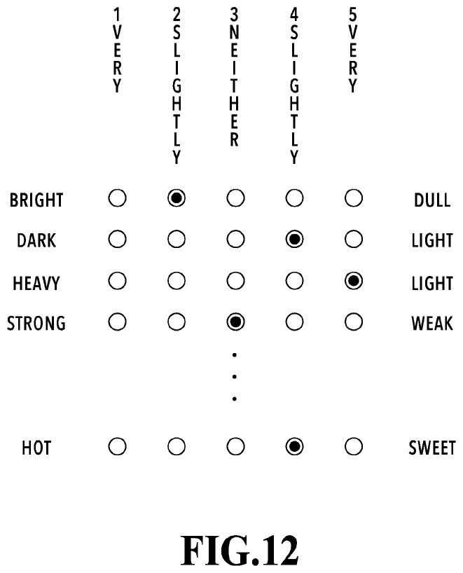

In S1101, the CPU 101 obtains a subjective evaluation of the impression of each poster. FIG. 12 is a diagram explaining an example of a subjective evaluation method of the impression of the poster. The CPU 101 presents the poster to a trial subject, and obtains, from the trial subject, the subjective evaluation of the impression received from the poster. In this case, a measurement method such as a semantic differential (SD) method or a Likert scale method can be used. FIG. 12 illustrates an example of a questionnaire that uses the SD method and in which pairs of adjectives representing impressions are presented to multiple evaluators and scoring is performed for the pairs of adjectives evoked by the target poster. The CPU 101 obtains subjective evaluation results of multiple posters from the multiple trial subjects, then determines an average value of answers for each pair of adjectives, and sets the average value as a representative score of the corresponding pair of adjectives. Note that the subjective evaluation method of the impression may be a method other than the SD method, and it is only necessary that a word expressing the impression and a score corresponding to this word are determined.

In S1102, the CPU 101 executes factor analysis of each of the subjective evaluation results obtained in S1101. In the case where the subjective evaluation result is used as it is, the number of the pairs of adjectives is equal to the number of dimensions, and the control is complex. Accordingly, it is desirable to reduce the number of dimensions to an efficient number of dimensions by using an analysis method such as principal component analysis or factor analysis. In the present embodiment, explanation is given assuming that the dimensions are reduced to four factors by the factor analysis. As a matter of course, this number may change depending on the selection of the pairs of adjectives in the subjective evaluation and the factor analysis method. Moreover, an output of the factor analysis is assumed to be standardized. Specifically, each factor is scaled such that a mean is 0 and a variance is 1 in the poster used in the analysis. This allows −2, −1, 0, +1, and +2 of the impression designated in the target impression designation component 204 to directly correspond to −2σ, −1σ, a mean value, +1σ, and +2σ in each impression, and calculation of the distance between the target impression and the estimated impression to be described later is facilitated. Note that, although the premium feel, affinity, liveliness, and substantial feel illustrated in FIG. 6A are described as the four factors in the present embodiment, these are names given for the sake of convenience to convey the impressions to the user through the user interface, and each factor is formed of multiple pairs of adjectives influencing one another. Moreover, the CPU 101 saves a formula (hereinafter, referred to as “impression conversion formula”) for conversion from the subjective evaluation results of the respective pairs of adjectives obtained by the factor analysis to the values of the respective impressions, in the HDD 104.

In S1103, the CPU 101 associates the poster image and the impression with each other. Although the quantification can be performed on the poster subjected to the subjective evaluation in the above-mentioned method, the estimation of the impression needs to be performed also for a poster to be created from here on without the subjective evaluation. The association of the poster image and the impression can be implemented by training a model that estimates the impression from the poster image. Specifically, for example, a deep learning method using convolution neural network (CNN) or visual transformer (ViT), a machine learning method using a decision tree, or the like can be used. In the present embodiment, the CPU 101 performs supervised deep learning using CNN with the poster image being an input and the four factors being an output. Specifically, the CPU 101 creates a deep learning model by performing training with the poster image subjected to the subjective evaluation and the corresponding impression being correct answers, and inputs an unknown poster image into this learning model to estimate the impression.

In S1104, the CPU 101 saves a model configuration and trained parameters of the deep learning model for impression estimation created in S1103, in the HDD 104.

The poster impression estimation component 218 expands the deep learning model saved in the HDD 104 on the RAM 103, and executes the deep learning model. The poster impression estimation component 218 forms an image of the poster data obtained from the layout component 217, and estimates the impression of the poster by causing the deep learning model expanded on the RAM 103 to operate with the CPU 101 or the GPU 109. Note that, although the deep learning method is used in the present embodiment, the present disclosure is not limited to this. For example, in the case where the machine learning method such as the decision tree is used, there may be created a machine learning model that extracts feature amounts such as a brightness average value, an edge amount, and the like of the poster image by performing image analysis and that estimates the impression based on these feature amounts.

### <Content Impression Quantification>

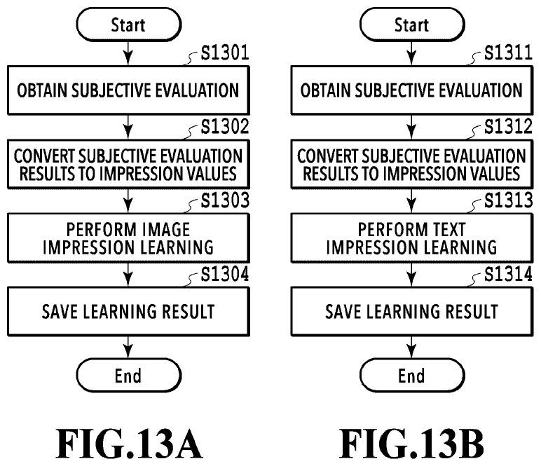

Next, a process (hereinafter, referred to as content impression quantification process) of quantifying the impression of each content is explained with reference to FIGS. 13A and 13B. The content impression quantification process is a preliminary process for executing a prompt impression estimation process (S1503 of FIG. 15) and an image impression estimation process (S1510 of FIG. 15). Hereinafter, the text and the image are also collectively referred to as “content”. The content impression quantification process is performed in a development stage of the poster creation application by the vendor or the like developing the poster creation application. Note that the content impression quantification process may be executed in the poster generation apparatus 100 or in an information processing apparatus different from the poster generation apparatus 100. Note that, in the case where the content impression quantification process is executed in the information processing apparatus different from the poster generation apparatus 100, the content impression quantification process is executed by a CPU of the information processing apparatus.

In the content impression quantification process, there is derived a correspondence relationship between the content itself and the impression of the content in a space in which the impression of the poster is quantified. This enables searching of the content suiting the impression of the poster desired to be generated. Note that the content impression quantification process is executed by, for example, causing an impression learning application for learning the impression of the content to operate in advance in the poster generation apparatus before the poster generation process. Moreover, since the content impression quantification process uses the impression conversion formula obtained in the poster impression quantification process illustrated in FIG. 11, the content impression quantification process needs to be executed after the poster impression quantification process.

FIGS. 13A and 13B are flowcharts illustrating the content impression quantification process. For example, the CPU 101 implements the flowcharts illustrated in FIGS. 13A and 13B by reading out programs stored in the HDD 104 to the RAM 103 and executing the programs. First, the image impression quantification process is explained with reference to FIG. 13A.

In S1301, the CPU 101 obtains a subjective evaluation of the impression of each image. A method similar to the method of the subjective evaluation executed in the poster impression quantification process may be performed for the subjective evaluation. After obtaining subjective evaluation results of multiple images from multiple trial subjects, the CPU 101 determines an average value of answers for each pair of adjectives, and sets the average value as a representative score of the corresponding pair of adjectives. Note that the subjective evaluation method of the impression may be a method other than the SD method, and it is only necessary that a word representing the impression and a score corresponding to this word are determined.

In S1302, the CPU 101 obtains the impression conversion formula obtained in the factor analysis performed in the poster impression quantification process, from the HDD 104, and applies the impression conversion formula to each of the subjective evaluation results obtained in S1301 to obtain impression values of each image. Applying the impression conversion formula obtained in the poster impression quantification process allows the impression of the image to be quantified on dimensions having the same meaning as the impression of the poster.

In S1303, the CPU 101 associates the image and the impression with each other. Although the quantification can be performed on the image subjected to the subjective evaluation in the above-mentioned method, the estimation of the impression needs to be performed also for an unknown image without the subjective evaluation, in the poster generation process of the present embodiment. The association of the image and the impression can be implemented by training a model that estimates the impression from the image. Specifically, for example, a deep learning method using convolution neural network (CNN) or visual transformer (ViT), a machine learning method using a decision tree, or the like can be used. In the present embodiment, the CPU 101 performs supervised deep learning using CNN with the image being an input and the four factors being an output. Specifically, the CPU 101 creates a deep learning model by performing training with the image subjected to the subjective evaluation and the corresponding impression being correct answers, and inputs an unknown image into this learning model to estimate the impression.

In S1304, the CPU 101 saves a model configuration and trained parameters of the deep learning model for impression estimation created in S1303, in the HDD 104.

Next, a text impression quantification process is explained with reference to FIG. 13B.

In S1311, the CPU 101 obtains a subjective evaluation of the impression of each text. A method similar to the method of the subjective evaluation executed in the poster impression quantification process may be performed for the subjective evaluation. After obtaining subjective evaluation results of multiple texts from multiple trial subjects, the CPU 101 determines an average value of answers for each pair of adjectives, and sets the average value as a representative score of the corresponding pair of adjectives. Note that the subjective evaluation method of the impression may be a method other than the SD method, and it is only necessary that a word representing the impression and a score corresponding to this word are determined.

In S1312, the CPU 101 obtains the impression conversion formula obtained in the factor analysis performed in the poster impression quantification process, from the HDD 104, and applies the impression conversion formula to each of the subjective evaluation results obtained in S1311 to obtain impression values of each text. Applying the impression conversion formula obtained in the poster impression quantification process allows the impression of the text to be quantified on dimensions having the same meaning as the impression of the poster.

In S1313, the CPU 101 associates the text and the impression with each other. Although the quantification can be performed on the text subjected to the subjective evaluation in the above-mentioned method, the estimation of the impression needs to be performed also for an unknown text without the subjective evaluation. The association of the text and the impression can be implemented by using, for example, a deep learning method using Transformer, a machine learning method using a decision tree, or the like to train a model that estimates the impression from the text. In the present embodiment, the CPU 101 performs supervised deep learning using Transformer with the text being an input and the four factors being an output. Specifically, the CPU 101 creates a deep learning model by performing training with the text subjected to the subjective evaluation and the corresponding impression being correct answers, and inputs an unknown text into this learning model to estimate the impression.

In S1314, the CPU 101 saves a model configuration and trained parameters of the deep learning model for impression estimation created in S1313, in the HDD 104.

### <Poster Generation Process>

FIGS. 14A and 14B are flowcharts illustrating the poster generation process executed by the poster generation component 210 of the poster creation application. For example, the CPU 101 implements the flowcharts illustrated in FIGS. 14A and 14B by reading out programs stored in the HDD 104 to the RAM 103 and executing the programs. In the present embodiment, explanation is given assuming that the CPU 101 executes the poster creation application to cause the components illustrated in FIG. 2 to execute a process corresponding to each function and implement the function. The flowcharts illustrated in FIGS. 14A and 14B are started based on an operation in which the user sets various setting items on the poster creation application and presses the OK button as described above.

In S1401, the poster creation application displays the generation condition setting screen 622 illustrated in FIG. 6A, on the display 105. The user inputs settings through the UI screen of the generation condition setting screen 622 by using the keyboard 106 and the pointing device 107.

In S1402, the poster creation condition designation component 201 and the target impression designation component 204 obtain the settings corresponding to these components, from the generation condition setting screen 622. Specifically, the poster creation condition designation component 201 obtains the size, the creation number, and the use application category of the poster designated by the user. The target impression designation component 204 obtains the target impression designated by the user.

In S1403, the poster creation application displays the content setting screen 601 on the display 105. The text designation component 202 and the image designation component 203 receive the designation of text or the designation of image by the user for each of setting items displayed in the content setting screen 601. The user inputs a setting value of each setting item by using the keyboard 106 and the pointing device 107. The image obtaining component 211 obtains the image data. Specifically, the image obtaining component 211 reads out the image file from the obtaining destination (for example, HDD 104) designated in the image designation component 203 to the RAM 103. Moreover, the CPU 101 obtains the character information inputted in the title box 602, the subtitle box 603, and the main text box 604.

In the case where the user designates an image, the user presses the image addition button 607 of the content setting screen 601. In the case where the image addition button 607 is pressed, the image designation component 203 displays the image designation screen 701, and receives selection of the designation method of an image by the user. In the case where the OK button 718 is pressed in the state where the radio button 706 of the image designation screen 701 is set to on and the prompt for causing the image generative AI to generate an image is inputted in the prompt box 716, the image generation component 220 starts the image generation process illustrated in FIG. 15.

### <Image Generation Process>

The image generation process is explained in detail by using FIG. 15. FIG. 15 is a flowchart explaining the image generation process in detail. The image generation process is executed by the image generation component 220. Specifically, the image generation process is executed by the obtaining component 301, the impression estimation component 302, the evaluation component 303, the change component 304, and the generation component 305 illustrated in FIG. 3.

In S1501, the obtaining component 301 obtains the prompt designated by the user in the prompt box 716 and the prompt change permission information set in the check box 719 on the image designation screen 701. Moreover, the obtaining component 301 stores the obtained prompt in the RAM 103.

In S1502, the obtaining component 301 switches the subsequent process depending on the contents of the prompt change permission information obtained in S1501. In the case where the prompt change permission information obtained by the obtaining component 301 indicates the information permitting the changing of the prompt (S1502; YES), the process transitions to S1503. In the case where the prompt change permission information indicates the information not permitting the changing of the prompt (S1502; NO), processes of S1503 to S1507 are skipped, and the process transitions to S1508.

In S1503, the impression estimation component 302 estimates the impression of the prompt obtained in S1501. The impression of the prompt can be estimated by using the learning model saved in the text impression quantification process illustrated in FIG. 13B.

In S1504, the evaluation component 303 determines a difference (impression difference) and a distance between the target impression obtained in S1402 and the impression of the prompt estimated in S1503. The determined impression difference is used as the change amount for changing the impression of the prompt to the target impression.

In S1505, the evaluation component 303 determines whether the distance determined in S1504 is larger than a predetermined threshold or not. In the case where the distance determined in S1504 is larger than the threshold, the evaluation component 303 causes the process to transition to S1506. In the case where the distance is not larger than the threshold, the evaluation component 303 causes the process to transition to S1508.

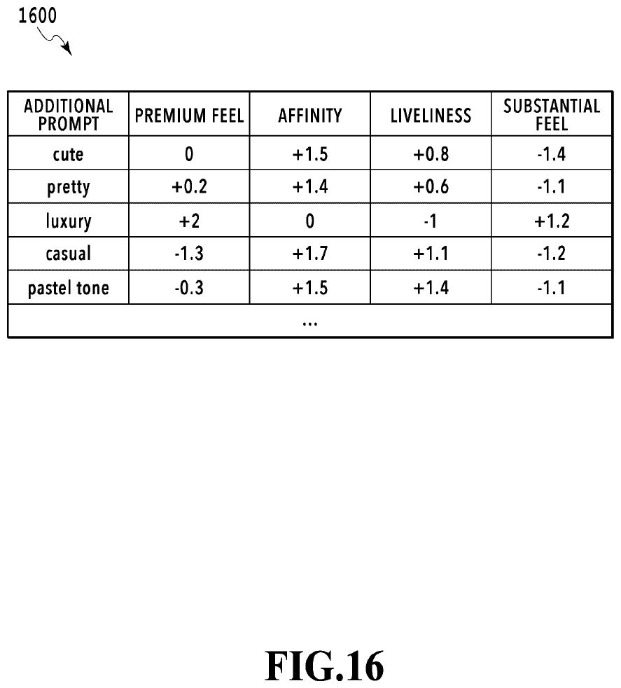

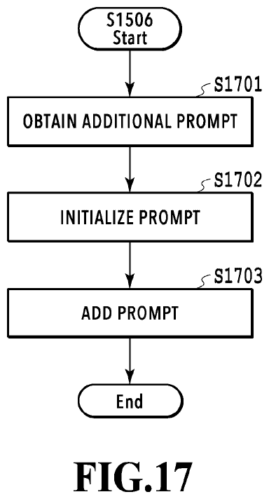

In S1506, the change component 304 changes the prompt obtained in S1501 to a prompt suiting the target impression. A prompt change process of S1506 is explained in detail by using FIGS. 16 and 17. Note that, in the present embodiment, a method in which one or multiple additional prompts that modify the base prompt being a prompt to be a base are added to the base prompt to determine a series of prompts is explained as a method of determining the changed prompt.

FIG. 16 is information in which character strings representing the additional prompts and impressions of the character strings are associated with one another. Hereinafter, this information is referred to as prompt impression table 1600. In the prompt impression table 1600 illustrated in FIG. 16, the character strings are written in English, and this is because English is used as a standard for prompts used as inputs of the generative AI. Any language such as Japanese may be used as long as it is a language supported by the generative AI. In each of the columns of premium feel, affinity, liveliness, and substantial feel, a numerical value indicating a level of an influence of each additional prompt on a corresponding one of the impression factors (premium feel, affinity, liveliness, and substantial feel) is set. Note that the numerical value indicating the impression corresponding to each additional prompt can be determined in a method similar to the method of the text impression quantification explained in FIG. 13B. Specifically, the impression of each additional prompt can be derived by performing the processes of S1311 to S1312.

Moreover, the impression of the additional prompt can be also derived by applying the impression estimation model saved in S1314 to the character string representing the additional prompt. Furthermore, the impression corresponding to each of the additional prompts can be also derived by the following method: the image generative AI generates an image by using, as input, a prompt obtained by combining each of the additional prompts and the base prompt with the base prompt fixed, and the impression of the generated image is estimated. For example, the image generative AI first generates an image by using a base prompt of “cafe” as input, and the impression of the generated image is estimated. Next, the image generative AI generates an image by using, as input, a prompt of “cute cafe” obtained by combining an additional prompt of “cute” with the base prompt, and the impression of the generated image is estimated. Then, a difference between the two impressions is determined, and the impression corresponding to the additional prompt in the base prompt can be thereby obtained. Performing a statistical process such as average determination on multiple impressions obtained by performing determination of the impression corresponding to the additional prompt as described above for various base prompts enables obtaining of the impression corresponding to the additional prompt. Note that the additional prompt only needs to be a word that influences the impression. For example, the additional prompt may be a single word such as “cute” or “casual”, or may be multiple words such as “pastel tone” or “soft lighting”.

FIG. 17 is a flowchart explaining the prompt change process of S1506. In the explanation of S1506, an operation in initial execution and an operation in second execution and beyond are separately explained.

First, the operation in the initial execution is explained. In S1701, the change component 304 obtains the additional prompts from the prompt impression table 1600 based on the impression difference (impression difference between the target impression and the impression of the prompt obtained in S1501) determined in S1504. In the case where the process of S1701 is executed after the determination of YES in S1505, that is in the case where the impression distance between the target impression and the impression of the prompt is larger than the predetermined threshold, the change component 304 refers to the impression difference determined in S1504. Then, the change component 304 determines a distance between the referred impression difference and each of the impressions of the additional prompts stored in the prompt impression table 1600. Then, the change component 304 obtains top N additional prompts in ascending order of the value of the determined distance, from the prompt impression table 1600. In the present embodiment, the change component 304 obtains top two additional prompts. In this case, a setting method of N may be a fixed value or may be such that a box (not illustrated) for designating the number of additional prompts to be obtained is prepared on the image designation screen 701, and the additional prompts as many as the designated number are obtained.

Note that, although the change component 304 obtains the additional prompts based on the distance between each of the impressions of the additional prompts and the impression difference between the target impression and the impression estimated from the prompt in the present embodiment, the present disclosure is not limited to this. The change component 304 may obtain top N additional prompts based on a distance between the target impression and each of the impressions of the additional prompts, in ascending order of this distance, from the prompt impression table 1600.

In S1702, the change component 304 initializes the prompt currently held in the RAM 103, and obtains the prompt (hereinafter, referred to as base prompt) to be the base before addition of each additional prompt.

### (Obtaining Method (1) of Base Prompt)

In the present embodiment, the change component 304 obtains the base prompt by rereading the prompt stored in the RAM 103 in S1501. Note that the obtaining method of the base prompt is not limited to this. The base prompt may be determined by obtaining methods (2) to (4) described below.

### (Obtaining Method (2) of Base Prompt)

In the case where the prompt obtained in S1501 includes the additional prompt (character string) registered in the prompt impression table 1600 in advance, the change component 304 initializes the prompt by deleting a portion of the included additional prompt. Specifically, a character string obtained by deleting the additional prompt portion from the prompt obtained in S1501 is used as the base prompt. In this case, it is possible to exclude a portion that is originally included in the prompt obtained in S1501 and that influences the impression. Accordingly, even in the case where the additional prompt is added in S1703, mismatch with the impression of the original prompt can be prevented.

### (Obtaining Method (3) of Base Prompt)

The change component 304 initialize the prompt by performing morphological analysis on the prompt obtained in S1501 and deleting a portion corresponding to an adjective. Specifically, a character string obtained by deleting a portion corresponding to an adjective from the prompt obtained in S1501 is used as the base prompt.

### (Obtaining Method (4) of Base Prompt)

The change component 304 initializes the prompt by performing syntax analysis on the prompt obtained in S1501 and deleting a portion corresponding to a modifier modifying a subject. Specifically, a character string obtained by deleting a portion corresponding to a modifier modifying a subject from the prompt obtained in S1501 is used as the base prompt. The obtaining methods (3) and (4) described above can also prevent mismatch between the impression given by the additional prompt and the impression of the original prompt as in the obtaining method (2) described above.

In S1703, the change component 304 changes the prompt by adding each additional prompt obtained in S1701 to the base prompt obtained in S1702.

### (Prompt Changing Method (1))

In the present embodiment, the change component 304 adds each additional prompt to an end of the base prompt by connecting the base prompt and the additional prompt with a comma, and thereby changes the prompt to a prompt for the obtained additional prompt. For example, in the case where the base prompt is “a cat” and the additional prompts are two additional prompts of “cute” and “pretty”, the change component 304 changes the prompt to two prompts of “a cate, cute” and “a cat, pretty”.

Note that, although prompts as many as the number of obtained additional prompts are determined by adding each of one or multiple obtained additional prompts to the prompt in the present embodiment in the above-mentioned prompt change method (1), the change method of the prompt is not limited to this. For example, the change component 304 may determine the changed prompt by prompt change methods (2) to (6) described below.

### (Prompt Change Method (2))

In the case where there are multiple additional prompts, the change component 304 may change the prompt as many times as the number of combinations of additional prompts. For example, in the case where the obtained additional prompts are two additional prompts of “cure” and “pretty”, the following three patterns are conceivable as the combinations of the additional prompts. Specifically, patterns of “cute” and “pretty” in which there is one additional prompt and a pattern of “cute, pretty” in which the two additional prompts are connected are conceivable. In this case, the change component 304 can perform prompt change for three patterns that is the number of combinations of the additional prompts, from the obtained two additional prompts. Collectively adding multiple prompts with similar tendencies in terms of impression as described above can reflect influences of the additional prompts more strongly.

### (Prompt Change Method (3))

Although the additional prompts are added to the base prompt by being connected with “,” in the prompt change methods (1) and (2) described above, the change method is not limited to this. The configuration may be such that a template for adding the additional prompt is held in the HDD 104, and the change component 304 adds, to the base prompt, a character string obtained by reflecting each additional prompt into the template. For example, in the case where the template is “with a (additional prompt) impression” and the additional prompt is “cute”, the change component 304 may add “with a cute impression” to the end of the base prompt. Using the template as described above enables the prompt to be more surely changed to an intended prompt.

### (Prompt Change Method (4))

Moreover, the change component 304 may perform syntax analysis on the base prompt and add each additional prompt in a form in which the additional prompt modifies a subject. For example, in the case where the base prompt is “a cat” and the additional prompt is “cute”, the fact that “cat” is the subject can be grasped through the syntax analysis. Accordingly, the change component 304 may insert the additional prompt in front of “cat”, and change the prompt to “a cute cat”. The prompt can be thereby changed in a more natural style.

### (Prompt Change Method (5))

Moreover, the change component 304 may add a prompt that gives a strong influence of an impression opposite to the target impression, as a negative prompt. The negative prompt is a prompt that instructs an AI model not to include a certain element in the generated image. Setting the prompt that gives a strong influence of an impression opposite to the target impression as the negative prompt can suppress generation of an image not suiting the target impression. In this case, in S1701, the change component 304 obtains top N prompts in descending order of the distance between the referred impression difference and each of the impressions of the additional prompts illustrated in the prompt impression table 1600. Then, in S1703, the change component 304 sets the obtained prompt as the negative prompt by connecting the negative prompt to the prompt with a comma.

### (Prompt Change Method (6))

Moreover, the change component 304 may add a prompt that gives a strong influence of an impression opposite to the target impression, together with a negative word. The negative word refers to a word that negates a word subsequent to the negative word such as “not” or “no”. Negating the prompt that gives a strong influence of an impression opposite to the target impression can suppress generation of an image not suiting the target impression. In this case, in S1701, the change component 304 obtains top N prompts in descending order of the distance between the referred impression difference and each of the impressions of the additional prompts illustrated in the prompt impression table. Then, in S1703, the change component 304 sets the prompt by adding the negative word in front of each of the obtained prompts and connecting the negative word to the prompt with a comma. That is the explanation of the operation of S1506 in the initial execution. That is the explanation of the first operation executed in S1506.

Next, the second and subsequent operations of S1506 are explained. The case where the second and subsequent operations are executed means that no image suiting the target impression is generated in the previously-performed prompt change. Accordingly, the change component 304 executes change that varies in processing contents from the already-executed prompt change to obtain a prompt with which an image suiting the target impression can be generated. Portions of the second and subsequent operations that are different from the operation in the initial execution are explained.

In S1701, the change component 304 obtains more additional prompts than in the initial execution. As an example, in the present embodiment, the change component 304 obtains two more additional prompts than the additional prompts obtained in the previous execution. For example, in the second execution, the change component 304 obtains top four additional prompts in ascending order of the distance between the referred impression difference and each of the impressions of the additional prompts in the prompt impression table 1600. Note that the number of obtained additional prompts may be any number as long as it is larger than the number in the previous execution. Moreover, the change component 304 may perform such control that the additional prompts obtained in the previous execution are excluded from the obtaining targets.

In S1702, the change component 304 performs the prompt initialization process, and determines the base prompt as in the initial execution.

In S1703, the change component 304 performs the prompt change as many times as the number of combinations of the obtained additional prompts. For example, since four additional prompts are obtained in the second execution, six patterns of additional prompts are conceivable.

Moreover, the change component 304 may perform further prompt addition. For example, the change component 304 may further add an emphasizing prompt such as “very” or “extremely” in front of the additional prompt or a suppression prompt such as “a little” or “slightly” to the additional prompt. Emphasizing or suppressing an influence of the additional prompt as described above can finely adjust the prompt suiting the target impression.

Moreover, the change component 304 may set weighting of the additional prompt. For example, in Stable Diffusion that is one type of image generative AI, designation of emphasis is possible by adding round brackets “( )” or square brackets “[ ]” to a prompt being a target. Moreover, designation of emphasis or suppression is possible by adding colon “:” and a number immediately after the prompt being the target. Furthermore, in Midjourney that is one type of image generative AI, designation of emphasis or suppression is possible by adding double-colon “::” and a number immediately after the prompt being the target. The change component 304 may change the prompt by using an expression of emphasis or suppression unique to the image generative AI as described above. For example, in the case where Stable Diffusion is used as the image generative AI, the change component 304 may change the prompt by adding brackets to the additional prompt or adding a value larger than 1.0 such as “:1.2” immediately after the additional prompt to emphasize the additional prompt. Similarly, the change component 304 may change the prompt by adding a value smaller than 1.0 such as “: 0.8” immediately after the additional prompt to suppress the additional prompt. Emphasizing or suppressing the influence of the additional prompt as described above enables fine adjustment of the prompt suiting the target impression.

As described above, the following processes are conceivable in the prompt change process in the second and subsequent operations of S1506.
(1) Additional prompts more than those in the initial execution are obtained, and multiple additional prompts are combined and added to the base prompt.
(2) A prompt indicating an emphasis word or suppression is added to the additional prompt.
(3) A prompt indicating emphasis or suppression unique to the model is added to perform weighting.

That is the explanation of the second and subsequent operations executed in S1506. In S1506, the change component 304 obtains one or multiple changed prompts. In the present embodiment, the change component 304 may select a predetermined number of changed prompts from the one or multiple changed prompts. Specifically, the change component 304 estimates the impression of each changed prompt, determines a distance to the target impression, and selects and outputs top N changed prompts in ascending order of the distance. In this case, the number of changed prompts can be prevented from becoming enormous. Thus, it is possible to reduce selection load in prompt selection of S1507 and image generation load in S1509 to be described later.

In S1507, the change component 304 selects a prompt to be actually used from prompt candidates including the prompt before the change and the one or multiple changed prompts. In the present embodiment, the change component 304 displays the prompt selection screen 810 illustrated in FIG. 8A on the display 105, and receives the prompt selection by the user.

In the case where this execution of S1507 is the second execution or beyond and there is the same prompt as the changed prompt selected in the previous execution, this prompt is excluded from the selection target. Note that, in the case where there is only one type of changed prompt, the change component 304 may display the prompt selection screen 801 illustrated in FIG. 8B on the display 105, and receive the prompt selection by the user. Since the prompt selection screen 801 illustrated in FIG. 8B has a form in which one of the prompt before the change and the changed prompt is selected, the prompt selection is easy, and an operation load of the user can be reduced.

Moreover, in the case where there is only one type of changed prompt, the change component 304 may not display the prompt selection screen 801, and perform subsequent processes by using the changed prompt. In this case, the user does not have to perform an operation, and the operation load of the user can be eliminated.

In S1508, the generation component 305 generates a random number as the initial number to be inputted into the image generative AI. A different value is randomly generated every time the random number is generated.

In S1509, the generation component 305 inputs the prompt obtained in S1501 or the prompt before the change or the changed prompt selected in S1507 and the random number generated in S1508 into the image generative AI, and generates an image. Note that the image generative AI only needs to use a known technique of generating an image from a prompt, and detailed explanation of the image generative AI is omitted. In the present embodiment, Stable Diffusion is used as the image generative AI. Note that other known image generative Als including Midjourney may be used, and an unknown image generative AI may also be used. Any method may be used as long as it is a technique of generating an image from a prompt according to contents of the prompt. Note that, in the case where there are multiple obtained prompts, the generation component 305 performs image generation for each of the prompts, and obtains multiple generated images. Moreover, the generation component 305 counts the number of times of image generation, and records the number in the RAM 103. Note that, in the case where S1506 and S1507 are executed and then a different prompt is used, the generation component 305 resets the count of the number of times of generation, and then performs the counting again. Moreover, the generation component 305 may hold the generated image in association with information on the prompt and the random number used in the generation of the generated image.

In S1510, the impression estimation component 302 estimates the impression of the generated image generated by the generation component 305 in S1509, and holds the estimated impression in association with the corresponding image.

In S1511, the evaluation component 303 determines a difference and a distance between the target impression obtained in S1402 and the estimated impression of the generated image estimated in S1510, and holds the difference and the distance in association with the generated image. The determined difference represents the change amount necessary for changing the impression of the generated image to an impression close to the target impression. Moreover, the smaller the value of the distance is, the closer the impression of the generated image is to the target impression.

In S1512, the evaluation component 303 obtains the number of times of image generation recorded in the RAM 103, and determines whether the number of times of generation is larger than a predetermined threshold (upper limit number) or not. In the case where the obtained number of times of generation is larger than the threshold (upper limit number), the evaluation component 303 causes the process to transition to S1513. In the case where the obtained number of times of generation does not exceed the predetermined threshold (upper limit number), the evaluation component 303 causes the process to transition to S1508. In the present embodiment, the evaluation component 303 determines whether the number of times of generation is larger than five or not. Note that the threshold (upper limit number) of the number of times of generation may be any number that is equal to or larger than one. The larger the threshold (upper limit number) is, the more the obtained image generation results are. The smaller the threshold (upper limit number) is, the fewer the obtained image generation results are, but the processing time can be reduced.

In S1513, the obtaining component 301 switches the subsequent process depending on the prompt change permission information obtained in S1501. In the case where the prompt change permission information obtained by the obtaining component 301 is the information permitting the changing of the prompt (S1513; YES), the process transitions to S1514. In the case where the prompt change permission information is the information not permitting the changing of the prompt (S1513; NO), the process transitions to S1515.

In S1514, the evaluation component 303 determines whether all distances (distance between the target impression and each of the impressions of the generated images) determined in S1511 are larger than a predetermined threshold or not. In the case where all distances determined in S1511 are larger than the threshold, the evaluation component 303 causes the process to transition to S1506. If not (in the case where there is at least one generated image for which the distance determined in S1511 is equal to or smaller than the threshold), the evaluation component 303 causes the process to transition to S1515.

Note that, in the case where the number of times of prompt change in S1506 exceeds the predetermined upper limit number and all distances determined in S1511 are larger than the predetermined threshold, the evaluation component 303 may not cause the process to return to S1506 and transition to a process different from the present flowchart. Specifically, in the case where no image close to the target impression is generated even with the prompt changed multiple times, for example, the evaluation component 303 may display a warning screen indicating that prompt change suiting the target impression is difficult, on the display 105, and then cancel the present flowchart. Alternatively, the evaluation component 303 may obtain and hold top N generated images in ascending order of the distance (distance between the target impression and each of the estimated impressions of the generated images) determined in S1511 up to this time point, and cause the process to transition to S1515.

In S1515, the generation component 305 selects an image to be actually used in the poster, from the generated images. In the present embodiment, the generation component 305 displays the image selection screen 901 on the display 105, displays the generated images for which the distance is determined to be smaller than the threshold in S1514, as the generated images 902, and receives image selection by the user. In the present embodiment, the generation component 305 displays all generated images on the image selection screen 901 in ascending order of the distance associated with each generated image. Note that the display order and the number of displayed images are not limited to these. For example, the generation component 305 may select a predetermined number of generated images in ascending order of the distance associated with each generated image, and display the selected generated images. In this case, the configuration may be such that a box for designating the number of images to be generated is prepared on the image designation screen 701, and the generated images as many as the designated number are selected (not illustrated). Moreover, the generation component 305 may display the generated images in random order without referring to the distances associated with the generated images.

Note that, although whether the prompt is to be changed or not is determined in both of S1502 and S1513 in the present embodiment, the determination may be performed in only one of S1502 and S1513. Specifically, in the case where whether the prompt change is to be performed or not is determined in S1502, the process may transition to S1515 with no determination performed in S1513. In this case, the image impression estimation performed in S1510 and the process of determining the impression difference and the distance of the image performed in S1511 may be skipped. Similarly, in the case where whether the prompt change is to be performed or not is determined in S1513, the process may transition to S1508 with no determination performed in S1502. In this case, the prompt impression estimation performed in S1503 and the process of determining the prompt impression distance performed in S1504 may be skipped. Determining execution or non-execution of the prompt change in only one of S1502 and S1513 allows the prompt change to be performed based on the impression of one of the inputted prompt and the generated image, while reducing processing load. That is the explanation of the image generation process executed in S1403. The description returns to FIGS. 14A and 14B.

A state where the target impression is designated and the image generated by using the prompt close to the target impression is displayed in the image designation region 605 of the content setting screen 601 is achieved by the processes of S1401 to S1403 described above.

In S1404, the selection numbers are determined such that posters corresponding to the creation number designated in the poster creation condition designation component 201 can be generated. Specifically, the skeleton selection component 214 determines the number of skeletons to be selected, the color scheme pattern selection component 215 determines the number of color scheme patterns to be selected, and the font selection component 216 determines the number of fonts to be selected. In the present embodiment, the layout component 217 is assumed to generate pieces of poster data as many as the number of skeletons× the number of color scheme patterns× the number of fonts. The skeleton selection component 214, the color scheme pattern selection component 215, and the font selection component 216 determine the number of skeletons to be selected, the number of color scheme patterns to be selected, and the number of fonts to be selected such that the number of posters to be generated is equal to or more than the creation number designated in the poster creation condition designation component 201. For example, the number of skeletons, the number of color scheme patterns, and the number of fonts may each be determined according to Formula 1 described below.

$$selection number = ⌈ \sqrt[3]{creation number \times 2} ⌉ \qquad ( 1 )$$

where ┌x┐ is the number of ceiling functions, and is the smallest integer that is not smaller than x.

For example, in the case where the creation number is six, the selection number is three, the number of pieces of poster data to be generated by the layout component 217 is 27, and the poster selection component 219 selects six out of the 27 pieces of poster data. The poster selection component 219 can thereby select posters whose impressions of the entire posters further match the target impression, from among the pieces of poster data generated as many as or more than the creation number. Note that the method of determining the selection number is not limited to this, and the selection number may be determined by another method. Moreover, the selection number may be a fixed value.

In S1405, the text designation component 202 and the image designation component 203 obtain the settings corresponding to these components from the content setting screen 601. Moreover, the image obtaining component 211 obtains the image data designated by the image designation component 203 or the image data generated in the image generation component 220, and holds the image data in the RAM 103.

In S1406, the image analysis component 212 executes the analysis process on the image data obtained in S1405, and obtains the feature amounts or information indicating features that relate to each image. The information indicating features includes, for example, meta information stored in the image. The feature amounts include image feature amounts that can be obtained by analyzing the image. These pieces of information are used in the object recognition process that is the analysis process. Note that, although the object recognition process is executed as the analysis process in the present embodiment, the present disclosure is not limited to this, and other analysis processes may be executed. Moreover, the process of S1406 may be omitted. Details of the process performed in the image analysis component 212 in S1406 are explained below.

The image analysis component 212 executes the object recognition process on each image obtained in S1405. In this case, a publicly-known method can be used for the object recognition process. In the present embodiment, objects are recognized by a discriminator created by deep learning. The discriminator outputs a likelihood of whether a certain pixel forming the image is a pixel forming each object or not in a value of 0 to 1, and recognizes that the object is in the image for the object exceeding a certain threshold. The image analysis component 212 can obtain the types and positions of the objects such as face, flower, food, building, stationary object, landmark, and pets including dog, cat, and the like by recognizing an object image.

In S1407, the skeleton obtaining component 213 obtains the skeletons matching various setting conditions. In the present embodiment, the skeletons are assumed to be such that one skeleton is described in one file and saved in the HDD 104. The skeleton obtaining component 213 sequentially reads out the skeleton files from the HDD 104 to the RAM 103, and keeps the skeletons matching the setting conditions on the RAM 103 while deleting the skeletons not matching the conditions from the RAM 103. FIG. 14B is a flowchart of a condition determination process performed by the skeleton obtaining component 213 in S1407. The condition determination process executed by the skeleton obtaining component 213 is explained with reference to FIG. 14B.

In S1421, for each of the skeletons read into the RAM 103, the skeleton obtaining component 213 determines whether the poster size designated in the poster creation condition designation component 201 matches the size of the skeleton. Note that, although the size match is checked in this process, matching of the aspect ratio alone is sufficient. In this case, the skeleton obtaining component 213 enlarges or reduces the coordinate system of the read skeleton to obtain a skeleton matching the poster size designated in the poster creation condition designation component 201.

In S1422, the skeleton obtaining component 213 determines whether the use application category designated in the poster creation condition designation component 201 matches the category of the skeleton. The use application category of the skeleton to be used only for a specific use application is described in the skeleton file, and this skeleton is prevented from being obtained except for the case where this use application category is selected. This can prevent the skeleton from being used in other use application categories in the case where the skeleton is designed specifically for a certain use application such as, for example, the case where a pattern invoking school is graphically drawn or the case where a pattern of sport goods is graphically drawn. Note that, in the case where no use application category is set in the generation condition setting screen 622, S1422 is skipped.

In S1423, the skeleton obtaining component 213 determines whether the number of image objects in the read skeleton matches the number of images obtained by the image obtaining component 211. In the case where the number of the image objects in the read skeleton matches the number of images obtained by the image obtaining component 211, the skeleton obtaining component 213 keeps this skeleton in the RAM 103. In the case where the numbers do not match, the skeleton obtaining component 213 deletes this skeleton from the RAM 103.

In S1424, the skeleton obtaining component 213 determines whether the text object of the read skeleton matches the character information designated in the text designation component 202. More specifically, the skeleton obtaining component 213 determines whether each type of character information designated in the text designation component 202 is present in the skeleton. For example, assume that character strings are designated in the title box 602 and the main text box 604 on the content setting screen 601, and blank is designated in the subtitle box 603. In this case, the skeleton obtaining component 213 searches all text objects in the skeleton, and determines that the skeleton is suitable in the case where the text object for which “title” is set as the type of character information in the metadata and the text object for which “main text” is set as the type are both found, and determines that the skeleton is unsuitable in other cases. In the case where the text object of the read skeleton matches the character information designated in the text designation component 202, the skeleton obtaining component 213 keeps this skeleton in the RAM 103. In the case where the text object does not match the character information, the skeleton obtaining component 213 deletes this skeleton from the RAM 103.

As described above, the skeleton obtaining component 213 keeps the skeletons in which the size, the use application category, the number of image objects, and the type of text object of the skeleton all match the conditions set in the generation condition setting screen 622, on the RAM 103. Note that, although the skeleton obtaining component 213 performs the determination for all skeleton files on the HDD 104 in the present embodiment, the present disclosure is not limited to this. For example, the poster creation application may hold a database in which file paths of the skeleton files are associated with the search conditions (skeleton size, the number of image objects, and type of text object) in advance, in the HDD 104. In this case, the skeleton obtaining component 213 can obtain the skeleton files at high speed by reading only the skeleton files determined to match the conditions as a result of searching on the database, from the HDD 104 to the RAM 103. Explanation returns to FIG. 14A.

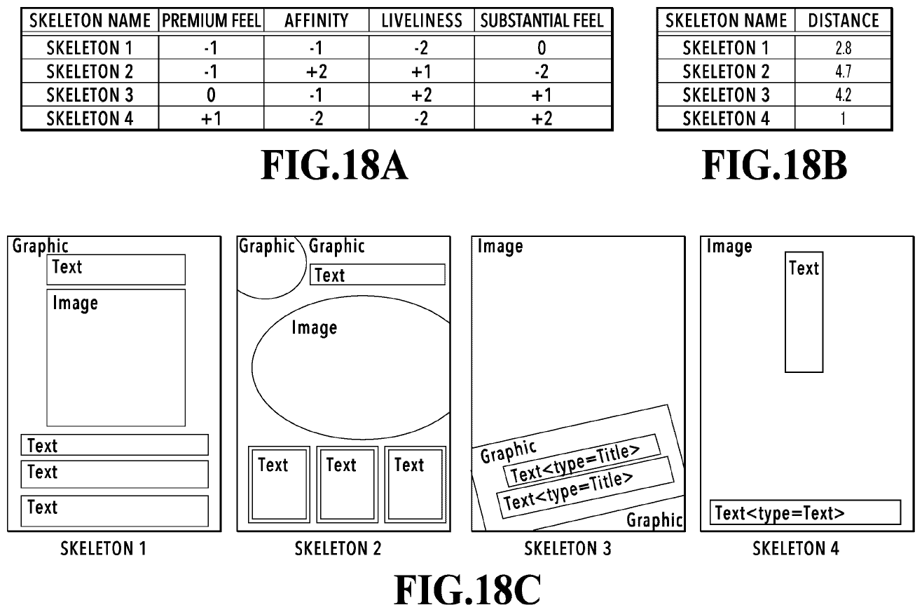

In S1408, the skeleton selection component 214 selects the skeletons matching the target impression designated in the target impression designation component 204 among the skeletons obtained in S1407. FIGS. 18A to 18C are diagrams explaining a method by which the skeleton selection component 214 selects the skeletons. FIG. 18A is a diagram illustrating an example of a table in which the skeletons are associated with the impressions. In the column of skeleton name in FIG. 18A, a file name of each skeleton is described, and the columns of premium feel, affinity, liveliness, and substantial feel each illustrate a number (numerical value) indicating a level of an influence of the skeleton on a corresponding one of the impression factors. This numerical value is a value indicating that −2 is low, −1 is slightly low, 0 is neither high nor low, +1 is slightly high, and +2 is high for the impression. First, the skeleton selection component 214 determines a distance between the target impression obtained from the target impression designation component 204 and the impression of each of the skeletons illustrated in the skeleton impression table of FIG. 18A. For example, in the case where the target impression is “premium feel +1, affinity −1, liveliness −2, and substantial feel +2”, the distance determined by the skeleton selection component 214 is as illustrated in FIG. 18B. The smaller the value indicated by the distance is, the closer the impression of the skeleton is to the target impression. Next, the skeleton selection component 214 selects top N skeletons in ascending order of the value indicated by the distance in FIG. 18B, N being the selection number. In the present embodiment, the skeleton selection component 214 is assumed to select top two skeletons. Specifically, the skeleton selection component 214 selects Skeleton 1 and Skeleton 4.

The value of N is determined depending on the conditions designated in the poster creation condition designation component 201. In the case where the selection number N is a variable value, the selection number N may be determined by Formula 1 described above, or determined by another method. For example, in the case where the creation number is designated to be six in the creation number box 614 on the generation condition setting screen 622, the poster generation component 210 generates six posters. In the layout component 217 to be described later, the posters are generated by combining the skeletons, the color scheme patterns, and the fonts selected in the skeleton selection component 214, the color scheme pattern selection component 215, and the font selection component 216. Accordingly, for example, selecting two skeletons, two color scheme patterns, and two fonts enables generation of 2×2×2=8 posters, and this can satisfy the condition of the creation number of six.

Moreover, each of the ranges of the impressions in the skeleton impression table in FIG. 18A does not have to be the same as the corresponding range of the impression designated in the target impression designation component 204. Although the range of the impression designated in the target impression designation component 204 is −2 to +2 in the present embodiment, the range of the impression in the skeleton impression table may be different from this range. In this case, the range in the skeleton impression table is scaled to match the range of the target impression, and then the above-mentioned distance calculation is executed. Furthermore, the distance determined by the skeleton selection component 214 is not limited to the Euclidean distance, and may be a Manhattan distance, a Cosine similarity, or the like as long as a distance between vectors can be determined. Moreover, the impression factors set to off with the radio buttons 612 are excluded from the distance determination calculation.

Note that, for example, the skeleton impression table is created in advance by estimating an impression of a poster image generated based on each skeleton with the color scheme pattern, the font, and the image and character data arranged on the skeleton fixed. Then, the skeleton impression table is saved in the HDD 104. Specifically, the impression of each of the poster images that are the same in the used images, the colors of used characters, and the like but vary in the arrangement of the characters, images, and the like is estimated, and characteristics relative to other skeletons are thereby formed into a table. In this case, it is desirable to perform a process of cancelling impressions given by the used color scheme pattern, images, and the like such as performing standardization across all estimated impressions, averaging impressions of multiple poster images generated from one skeleton by using multiple color scheme patterns and multiple images, or the like. Influences of the arrangement on the impression can be thereby formed into a table, the influences being, for example, such an influence that an impression of a skeleton with a small image is determined based on elements such as graphics and characters irrespective of the image and such an influence that liveliness is high in the case where images and characters are arranged in a tilted manner.

FIG. 18C illustrates examples of skeletons corresponding to Skeleton 1 to Skeleton 4 in FIG. 18A. For example, in Skeleton 1, an image object and text objects are regularly arranged, and the area of the image is small. Accordingly, liveliness is low. In Skeleton 2, a graphical object and an image object are circular. Accordingly, affinity is high, and substantial feel is low. In Skeleton 3, an image object is arranged in a large area, and a tilted graphical object is arranged to be laid over the image object. Accordingly, liveliness is high. In Skeleton 4, an image is arranged over the entire skeleton, and a text object is minimized. Accordingly, substantial feel is high, and liveliness is low. As described above, in the case where the poster image includes characters or an image, poster images varying in the target impression are generated by the arrangement method of the characters or the image. Note that the method of creating the skeleton impression table is not limited to this, and the skeleton impression table may be estimated from characteristics of arrangement information itself such as areas and coordinates of images and title character strings, or may be manually adjusted. The skeleton impression table is saved in the HDD 104, and the skeleton selection component 214 reads out the skeleton impression table from the HDD 104 to the RAM 103, and refers to the skeleton impression table.

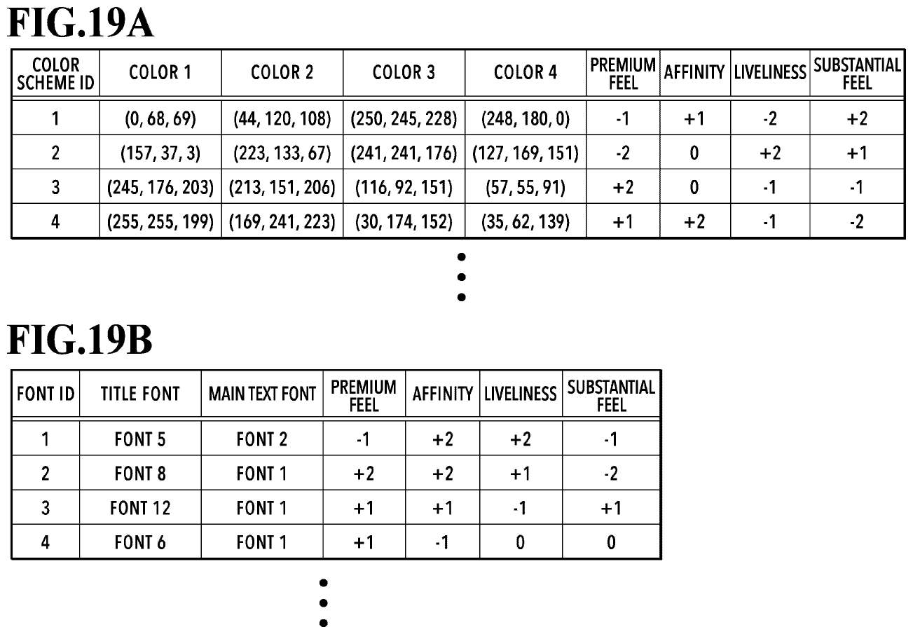

In S1409, the color scheme pattern selection component 215 selects the color scheme patterns matching the target impression designated in the target impression designation component 204. The color scheme pattern selection component 215 refers to an impression table corresponding to the color scheme patterns, and selects the color scheme patterns depending on the target impression, in a method similar to S1407. FIG. 19A illustrates an example of the color scheme pattern impression table in which the color scheme patterns are associated with the impressions. The color scheme pattern selection component 215 determines a value of a distance between the target impression and a value of a distance of an impression indicated by the columns of premium feel to solid feel in FIG. 19A, and selects top N color scheme patterns in ascending order of the value of the distance, N being the selection number. In the present embodiment, top two color scheme patterns are assumed to be selected. Note that, like the skeleton impression table, in the color scheme pattern impression table, tendencies of impressions of the color scheme patterns can be formed into a table by: creating posters varying in the color scheme pattern with the elements other than the color scheme pattern such as the skeleton, the font, and the image fixed; and estimating the impressions of the posters.

In S1410, the font selection component 216 selects combinations of fonts matching the target impression designated in the target impression designation component 204. The font selection component 216 refers to an impression table corresponding to the fonts, and selects the fonts depending on the target impression, in a method similar to S1407. FIG. 19B illustrates an example of the font impression table in which the fonts are associated with the impressions. The font selection component 216 determines a value of a distance between the target impression and a value of a distance of an impression indicated by the columns of premium feel to substantial feel in FIG. 19B, and selects top N fonts in ascending order of the value of the distance, N being the selection number. Note that, like the skeleton impression table, in the font impression table, tendencies of impressions of the fonts can be formed into a table by: creating posters varying in the font with the elements other than the font such as the skeleton, the color scheme pattern, and the image fixed; and estimating the impressions of the posters.

In S1411, the layout component 217 sets the character information, the images, the color schemes, and the fonts for the skeletons selected in the skeleton selection component 214, and generates posters.

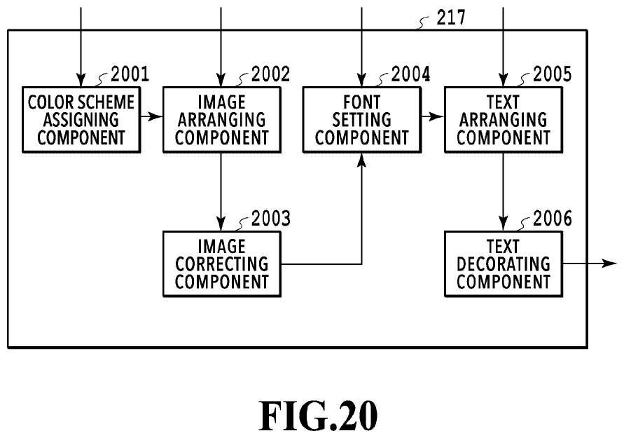

The layout process of S1411 and a software configuration of the layout component 217 are explained in detail by using FIGS. 20, 21, 22A to 22C, and 23A to 23C.

FIG. 20 is an example of a software block diagram explaining the layout component 217 in detail. The layout component 217 includes a color scheme assigning component 2001, an image arranging component 2002, an image correcting component 2003, a font setting component 2004, a text arranging component 2005, and a text decorating component 2006.

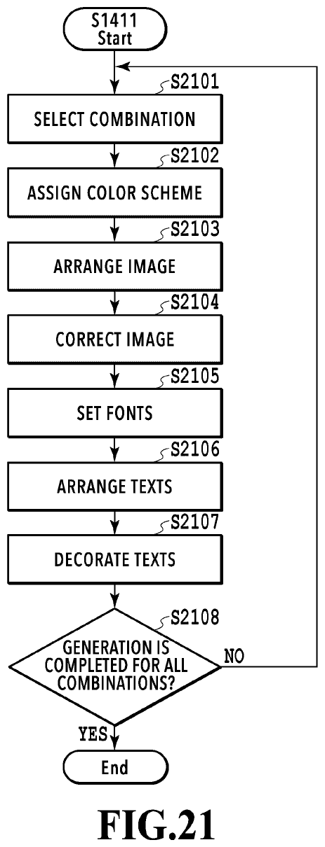

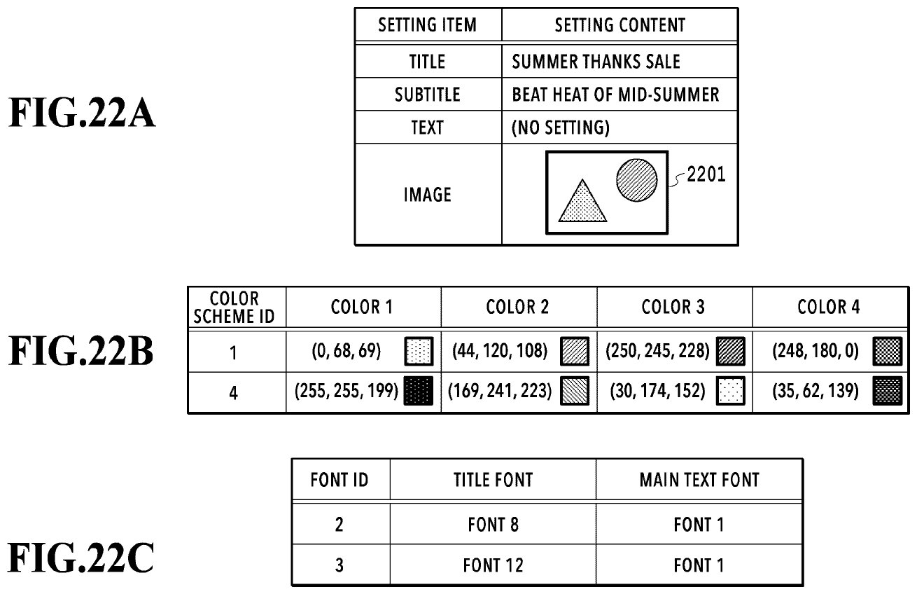

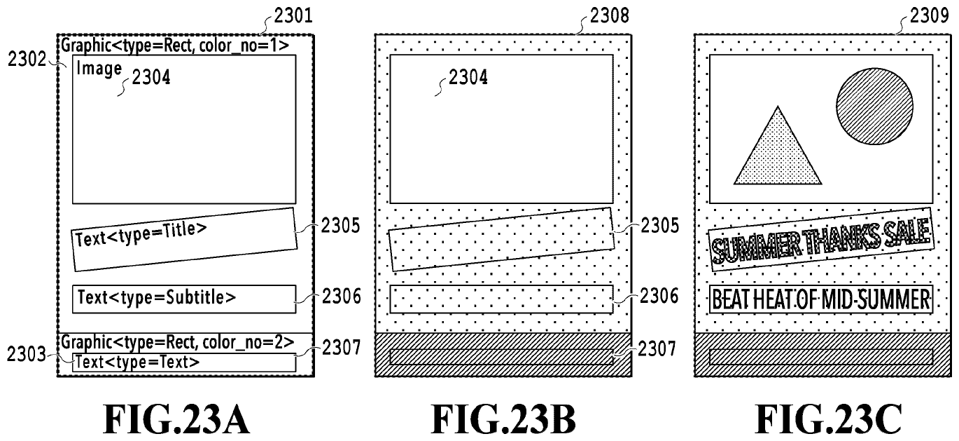

FIG. 21 is a flowchart explaining the layout process of S1411 in detail. Moreover, FIGS. 22A to 22C are diagrams explaining information inputted into the layout component 217. FIG. 22A is a table summarizing the character information designated in the text designation component 202 and an image 2201 designated in the image designation component 203. FIG. 22B is an example of a table illustrating the color scheme patterns obtained from the color scheme pattern selection component 215, and FIG. 22C is an example of a table illustrating the fonts obtained from the font selection component 216. FIGS. 23A to 23C are diagrams explaining a procedure of the process of the layout component 217.

The layout process of S1411 is explained in detail with reference to FIG. 21.

In S2101, the layout component 217 lists all combinations of the skeletons obtained from the skeleton selection component 214, the color scheme patterns obtained from the color scheme pattern selection component 215, and the fonts obtained from the font selection component 216. The layout component 217 sequentially generates pieces of poster data for the respective combinations by performing the layout process of S2102 and beyond. For example, in the case where: the number of skeletons obtained from the skeleton selection component 214 is three; the number of color scheme patterns obtained from the color scheme pattern selection component 215 is two; and the number of fonts obtained from the font selection component 216 is two, the layout component 217 generates 3×2×2=12 pieces of poster data. Next, in S2101, the layout component 217 selects one of the listed combinations, and executes the processes of S2102 to S2107.

In S2102, the color scheme assigning component 2001 assigns the color scheme pattern obtained from the color scheme pattern selection component 215, to the skeleton obtained from the skeleton selection component 214. FIG. 23A is a diagram illustrating an example of the skeleton. In the present embodiment, explanation is given of an example in which a color scheme pattern with a color scheme ID of 1 in FIG. 22B is assigned to a skeleton 2301 in FIG. 23A. The skeleton 2301 in FIG. 23A is formed of two graphical objects 2302 and 2303, one image object 2304, and three text objects 2305, 2306, and 2307. First, the color scheme assigning component 2001 assigns colors to each of the graphical objects 2302 and 2303. Specifically, the color scheme assigning component 2001 assigns a corresponding color from the color scheme pattern, based on a color scheme number that is metadata described in the graphical object. Next, the color scheme assigning component 2001 assigns, for example, the last color in the color scheme pattern to the text object (Text<type=Title>) whose metadata is type and whose attribute is “title” among the text objects. Specifically, in the present embodiment, Color 4 is assigned to the characters arranged in the text object 2305. Next, the color scheme assigning component 2001 sets a character color for characters arranged in each of the text objects 2306 and 2307 whose metadata is type and whose attributes are attributes other than “title” among the text objects, based on brightness of a background of the text object. In the present embodiment, the character color is set to white in the case where the brightness of the background of the text object is equal to or lower than a threshold, and is set to black if not. FIG. 23B is a diagram illustrating a state of a skeleton 2308 after execution of the color scheme assigning process described above. The color scheme assigning component 2001 outputs the skeleton data 2308 subjected to the color scheme assignment to the image arranging component 2002.

In S2103, the image arranging component 2002 arranges the image data obtained from the image analysis component 212 on the skeleton data 2308 obtained from the color scheme assigning component 2001, based on attached analysis information. In the present embodiment, the image arranging component 2002 assigns the image data 2201 to the image object 2304 in the skeleton. Moreover, in the case where the aspect ratio of the image object 2304 varies from that of the image data 2201, the image arranging component 2002 crops the image data 2201 such that the aspect ratio of the image data 2201 matches the aspect ratio of the image object 2304. More specifically, the image arranging component 2002 crops the image data 2201 based on a position of an object obtained by analyzing the image data 2201 with the image analysis component 212 such that an object region reduced by the cropping is minimized. Note that the cropping method is not limited to this, and other cropping methods such as, for example, cropping a center portion of the image or adjusting a composition such that a face position forms a triangular composition may be used. The image arranging component 2002 outputs the skeleton data subjected to the image assignment to the image correcting component 2003.

In S2104, the image correcting component 2003 obtains the skeleton data subjected to the image assignment from the image arranging component 2002, and corrects the image arranged in the skeleton. In the present embodiment, in the case where the resolution of the image is insufficient, an up-sampling process by a super-resolution process is performed. First, the image correcting component 2003 determines whether the image arranged in the skeleton satisfies a certain resolution. For example, assume that an image of 1,600 px×1,200 px is assigned to a region of 200 mm×150 mm on the skeleton. In this case, the print resolution of the image can be calculated by using Formula 2.

$$\frac{1600}{200 \div 25. 4} \approx 203 [ dpi ] \qquad ( 2 )$$

Next, in the case where the image correcting component 2003 determines that the print resolution of the image is lower than a threshold, the image correcting component 2003 improves the resolution by performing the super-resolution process. Meanwhile, in the case where the image correcting component 2003 determines that the print resolution of the image is equal to or higher than the threshold and the image has a sufficient resolution, no particular image correction is performed. In the present embodiment, the super-resolution process is performed in the case where the print resolution of the image is lower than 300 dpi.

In S2105, the font setting component 2004 sets the fonts obtained from the font selection component 216 for the skeleton data obtained from the image correcting component 2003 and subjected to the image correction. FIG. 23C is an example of the combinations of fonts selected by the font selection component 216. In the present embodiment, explanation is given of an example of assigning fonts in the case where the fonts assigned to the skeleton data subjected to the image correction are fonts of font ID “2” in FIG. 22C. In the present embodiment, the fonts are set for the text objects 2305, 2306, and 2307 in the skeleton 2308. Note that, in the poster, a font that stands out is set for the title from the viewpoint of noticeability, and a font that is easily readable is set for characters other than the title from the viewpoint of viewability in many cases. Accordingly, in the present embodiment, the font selection component 216 selects two types of fonts that are a title font and a main text font. The font setting component 2004 sets the title font for the text object 2305 whose attribute is “title” and sets the main text font for the other text objects 2306 and 2307. The font setting component 2004 outputs the skeleton data subjected to the font setting to the text arranging component 2005. Note that, although the font selection component 216 selects two types of fonts in the present embodiment, the present disclosure is not limited to this, and for example, only the title font may be selected. In this case, the font setting component 2004 uses a font corresponding to the title font as the main text font. Specifically, the main text font matching the type of the title font may be set as follows: for example, in the case where a font of a Gothic family is used for the title, a typical Gothic font with high readability is used for the other text objects, and in the case where a font of a Ming family is used for the title, a typical Ming font is used for the other text objects. As a matter of course, the title font and the main text font may be identical. Moreover, different fonts may be used as follows depending on a degree at which the text objects are desired to be made noticeable: for example, the title font is used for the text objects of the title and the subtitle while the main text font is used for the other text objects; or the title font is used for characters of a certain font size or larger.

In S2106, the text arranging component 2005 arranges the texts designated in the text designation component 202 on the skeleton data obtained from the font setting component 2004 and subjected to the font setting. In the present embodiment, texts illustrated in FIG. 22A are assigned with reference to the attributes of metadata of the text objects in the skeleton. Specifically, “Summer Thanks Sale” whose attribute is title is assigned to the text object 2305, and “Beat Heat of Mid-Summer” whose attribute is subtitle is assigned to the text object 2306. Since no main text is set, nothing is assigned to the text object 2307. FIG. 23C illustrates a skeleton 2309 that is an example of skeleton data after the process by the text arranging component 2005. The text arranging component 2005 outputs the skeleton data 2309 subjected to the text arrangement to the text decorating component 2006.

In S2107, the text decorating component 2006 decorates the text objects in the skeleton obtained from the text arranging component 2005 and subjected to the text arrangement. In the present embodiment, in the case where a color difference between the title character and a background region of the title character is equal to or less than a threshold, a process of adding an outline to the title character is performed. This improves the readability of the title. The text decorating component 2006 outputs the decorated skeleton data, that is the poster data for which the layout is completely finished, to the poster impression estimation component 218.

In S2108, the layout component 217 determines whether the poster data is generated in all combinations. In the case where the layout component 217 determines that the poster data is generated in all combinations of the skeletons, the color scheme patterns, and the fonts, the layout component 217 terminates the layout process, and transitions to S1412. In the case where the layout component 217 determines that the poster data is not generated in all combinations, the process returns to S2101, and the poster data is generated in a combination in which the poster data is not generated yet.

The layout process of S1411 has been described above. Description returns to the explanation of FIG. 14A.

In S1512, the poster impression estimation component 218 associates an estimated impression, obtained by executing a rendering process on each piece of poster data obtained from the layout component 217 and estimating the impression of the rendered poster image, with the poster data. Note that the rendering process is a process of converting the poster data to the image data. For example, even in posters of the same color scheme pattern, the arrangement varies in the case where the skeleton varies. Accordingly, an area in which each color is actually used varies. Thus, it is necessary to evaluate not only the tendency of the impression of each of the color scheme pattern and the skeleton but also the impression of the final poster. Accordingly, the present process is executed at this timing. This allows evaluation of not only the impression of each of the elements in the poster such as the color scheme and the arrangement but also the impression of the final poster in which the image and the characters are included and laid out.

In S1413, the poster selection component 219 selects the poster to be outputted to the display 105 (to be presented to the user) based on the pieces of poster data obtained from the poster impression estimation component 218 and the estimated impressions associated with the pieces of poster data. In the present embodiment, the poster selection component 219 selects a poster in which a distance between the target impression and the estimated impression of the poster is equal to or less than a predetermined threshold.

Note that a Euclidean distance is used as the distance in the present embodiment. The smaller the value indicated by the Euclidean distance is, the closer the estimate impression is to the target impression. Moreover, the distance determined by the poster selection component 219 is not limited to the Euclidean distance, and may be a Manhattan distance, a Cosine similarity, or the like as long as a distance between vectors can be determined.

Moreover, in the case where the number of selected posters is less than the creation number designated in the poster creation condition designation component 201, the poster selection component 219 selects posters for filling an insufficient amount, in ascending order of the value of the distance between the target impression and the estimated impression of each poster. Note that, although the poster selection component 219 selects the posters filling the insufficient amount in the present embodiment, the present disclosure is not limited to this. For example, in the case where the number of posters selected by the poster selection component 219 is less than the creation number, information indicating that the number of posters is insufficient may be displayed on the poster preview screen 1001 (FIG. 10). Alternatively, the poster selection component 219 may select the posters filling the insufficient amount, and then display the posters on poster preview screen 1001 such that the posters for which the value of the distance between the target impression and the estimated impression is equal to or smaller than the threshold are distinguishable from the posters for which the value is larger than the threshold. Moreover, for example, the configuration may be such that, in the case where the number of selected posters is insufficient, the process returns to S1404, and the selection numbers of the skeletons, the color scheme patterns, and the fonts are increased.

In S1414, the poster display component 205 renders each piece of poster data selected by the poster selection component 219, and outputs the poster image to the display 105. Specifically, the poster image is displayed on the poster preview screen 1001 of FIG. 10.

That is the explanation of the poster generation process in which the prompt is changed based on the target impression designated by the user and then the poster is generated based on the target impression. As explained above, in the poster creation application of the first embodiment, the prompt is changed based on the information (impression difference and distance) indicating the difference between the target impression designated by the user and the impression estimated from the prompt. Moreover, the prompt is changed based on the information (impression difference and distance) indicating the difference between the target impression and the impression estimated from the image generated by using the prompt. The prompt that varies depending on the target impression designated by the user is thereby determined, and the image generated by using the determined prompt can be arranged in the poster. Accordingly, in the case where a content to be arranged in the poster is generated by the generative AI, steps of designation of the prompt and check of the generated image that are otherwise performed by the user are automated, and the usability is improved. Moreover, since the content is generated to be close to the target impression designated by the user, the number of trials performed until a content as intended by the user is generated can be reduced. Accordingly, it is possible to improve usability in obtaining of a content to be arranged in a creation product such as a poster in an information processing apparatus that generates data of the creation product.

### Modified Example of First Embodiment

In the first embodiment, in S1508 to S1512 in the image generation process illustrated in FIG. 15, the generation of images with different random numbers (initial values of images) and the evaluation of image impressions are repeated until the number of times of execution reaches the predetermined upper limit number. Then, in S1513 to S1514, execution or non-execution of the prompt change is determined based on the evaluation results of the impressions for all generated images. However, the flow of the image generation process is not limited to this.

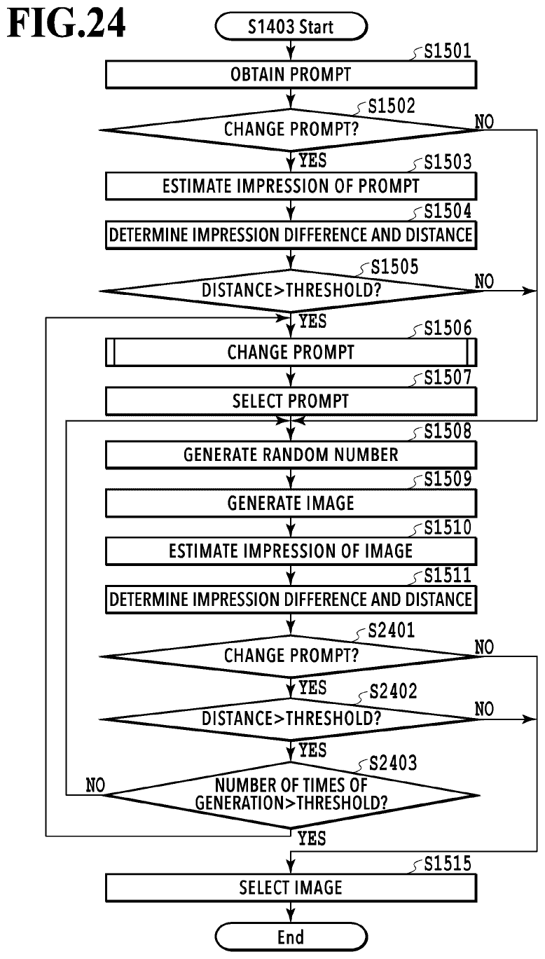

FIG. 24 is a flowchart explaining an image generation process in a modified example of the first embodiment in detail. Note that, since processes in the present flowchart that are denoted by the same reference numerals as those in the flowchart of FIG. 15 are the same as those in the first embodiment, explanation thereof is omitted.

S1501 to S1511 in the flowchart of FIG. 24 are the same as those in the first embodiment. Specifically, the poster creation application determines the impression difference and the distance between the target impression designated by the user and the estimated impression of the inputted prompt, and in the case where the value of the distance is larger than the predetermined threshold, changes the inputted prompt based on the impression difference. Moreover, the poster creation application inputs the changed prompt and the random number into the generative AI, and causes the generative AI to generate an image. The poster creation application estimates the impression of the image generated by the generative AI, and determines the distance between the target impression and the estimated impression of the generated image. Then, the process proceeds to S2401.

In S2401, the obtaining component 301 switches the subsequent process depending on the prompt change permission information obtained in S1501. In the case where the prompt change permission information obtained by the obtaining component 301 indicates the information permitting the prompt change (S2401; YES), the process transitions to S2402. In the case where the prompt change permission information indicates the information not permitting the prompt change (S2401; NO), the process transitions to S1515.

In S2402, the evaluation component 303 determines whether the distance determined in S1511 is larger than a predetermined threshold or not. In the case where the distance between the target impression determined in S1511 and the estimated impression of the generated image is larger than the threshold, the evaluation component 303 causes the process to transition to S2403. In the case where the distance is not larger than the threshold, the evaluation component 303 causes the process to transition to S1515.

In S2403, the generation component 305 obtains the number of times of image generation recorded in the RAM 103, and determines whether the number of times of generation is larger than a predetermined threshold or not. In the case where the obtained number of times of trial is larger than the threshold, the evaluation component 303 causes the process to transition to S1506, and the prompt change process is executed. In the case where the obtained number of times of trial is not larger than the threshold, the process transitions to S1508, and the random number is generated.

As explained above, according to the flow illustrated in FIG. 24, an image is generated by using one random number in S1508 to S1511, and every time an image is generated, an impression of the generated image is evaluated in S2401 to S2402 to determine whether the prompt is to be changed or not. This can provide an effect of enabling completion of the image generation process in the minimum required number of image generation, in addition to the effects of the first embodiment.

### Second Embodiment

In the first embodiment, the evaluation is performed by comparing the target impression and the impression of the prompt inputted by the user, and the prompt is changed to suit the target impression, based on the result of this evaluation. Moreover, explanation is given of the example in which an image is generated from the changed prompt and a poster is generated by using the generated image. In a second embodiment, the poster creation application converts a style of an image designated by the user (hereinafter, referred to as designated image) such that the impression of the designated image becomes close to the target impression. Then, the poster creation application generates a poster by using the image after the conversion. In this case, a prompt to be used for the style conversion is determined such that an impression of the image converted by using this prompt (converted image) becomes close to the target impression. Thus, the prompt for conversion to an image suiting the target impression can be determined based on the image designated by the user, and the image can be subjected to the style conversion by using the determined prompt, and be used for poster generation. Note that the image designated by the user includes the image data saved in the HDD 104, the image data obtained via the network, the application material images, the cooperation material images obtained from the external image providing service, and the AI generated images generated by the image generative AI.

### <Software Block Diagram>

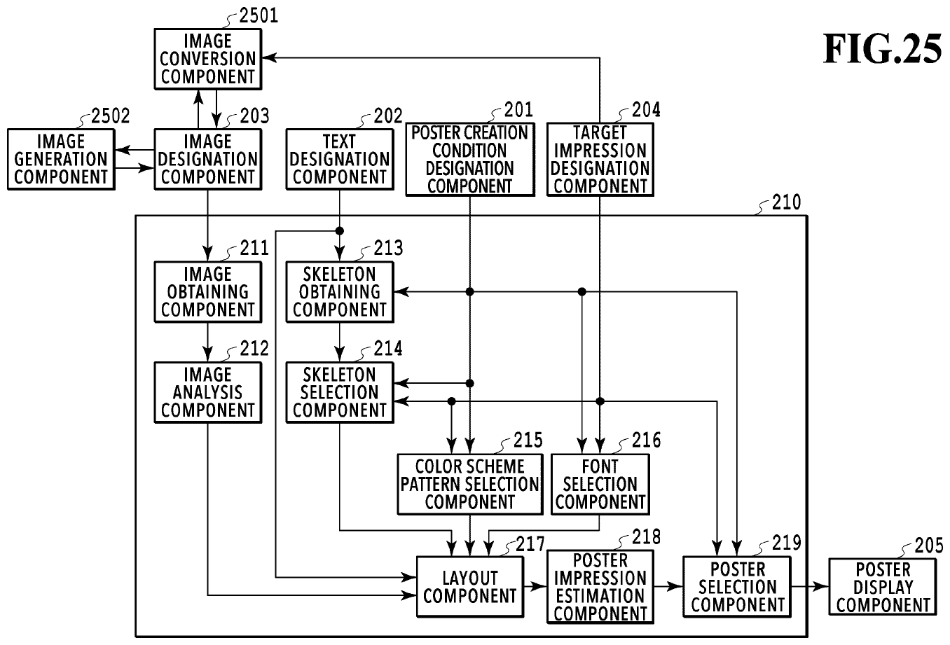

FIG. 25 is a software block diagram of the poster creation application in the second embodiment. As illustrated in FIG. 25, the poster creation application includes the poster creation condition designation component 201, the text designation component 202, the image designation component 203, the target impression designation component 204, the poster display component 205, an image generation component 2502, an image conversion component 2501, and the poster generation component 210. The poster generation component 210 includes the image obtaining component 211, the image analysis component 212, the skeleton obtaining component 213, the skeleton selection component 214, the color scheme pattern selection component 215, the font selection component 216, the layout component 217, the poster impression estimation component 218, and the poster selection component 219 as in the first embodiment. The poster creation application is different from the poster creation application (FIG. 2) of the first embodiment in that the image conversion component 2501 is added. Moreover, the image generation component 2502 is denoted by a different reference numeral because processing contents thereof are different from those in the first embodiment. Since the configurations in FIG. 25 denoted by the same reference numerals as those in FIG. 2 are the same as those in the first embodiment, explanation thereof is omitted.

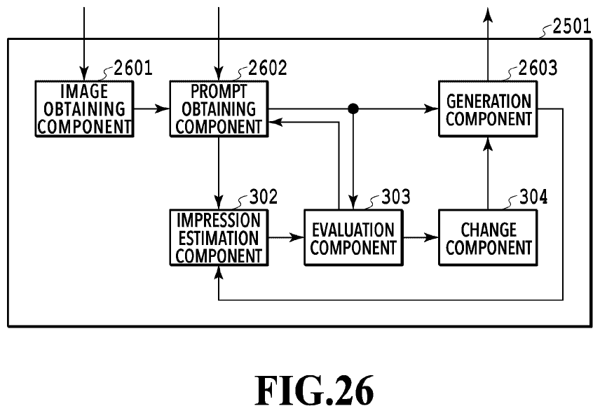

FIG. 26 is a software block diagram of the image conversion component 2501. As illustrated in FIG. 26, the image conversion component 2501 includes an image obtaining component 2601, a prompt obtaining component 2602, the impression estimation component 302, the evaluation component 303, the change component 304, and a generation component 2603. Since the impression estimation component 302, the evaluation component 303, and the change component 304 in FIG. 26 are the same as the impression estimation component 302, the evaluation component 303, and the change component 304 in the image generation component 220 of the first embodiment, explanation thereof is omitted.

The image obtaining component 2601 obtains the image designated in the image designation component 203. The image designated in the image designation component 203 is the same as that in the first embodiment, and includes the image data saved in the HDD 104, the application material images, the cooperation material images, and the AI generated images. In the second embodiment, the image designation component 203 displays an image designation screen 2801 for designation of an image, and receives image designation by the user. The image designation screen 2801 is described later. The image obtaining component 2601 obtains the image designated by the user from the image designation component 203, and obtains the target impression designated by the user from the target impression designation component 204.

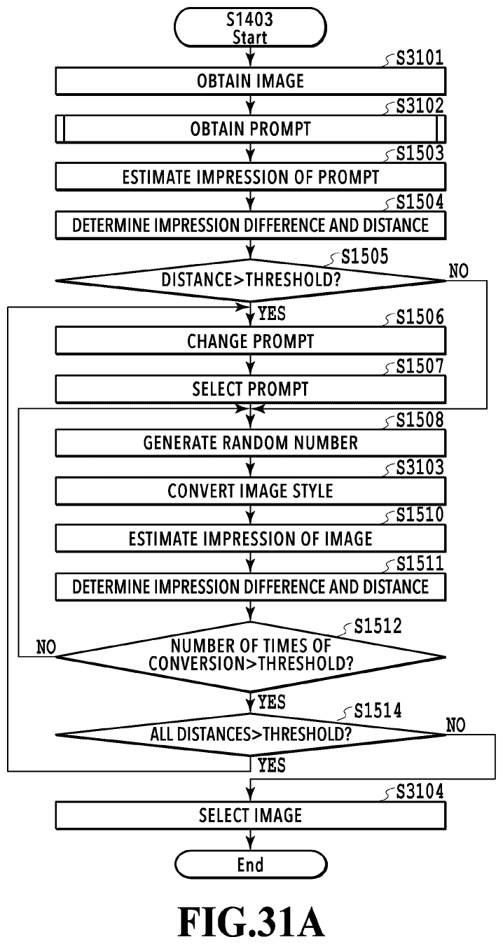

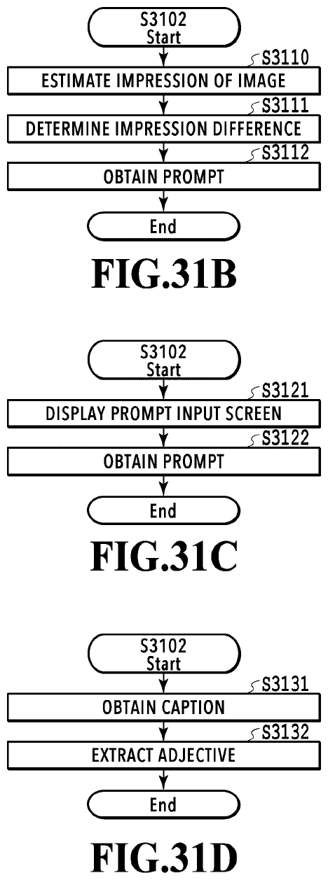

The prompt obtaining component 2602 obtains a prompt based on the image obtained by the image obtaining component 2601. A method of obtaining the prompt is described later (FIGS. 31B to 31D). The generation component 2603 converts the image obtained by the image obtaining component 2601 to an image to be used in the poster by using the prompt obtained by the prompt obtaining component 2602 and the image generative AI. Moreover, the image conversion component 2501 changes the prompt obtained by the prompt obtaining component 2602 based on a difference between the target impression and an impression of the prompt obtained by the prompt obtaining component 2602 or a difference between the target impression and an impression of the image generated or converted by the image generative AI. The image conversion component 2501 outputs the converted image converted by the generation component 2603 to the image designation component 203.

The image generation component 2502 of the second embodiment obtains the prompt from the image designation component 203, and generates the image to be used in the poster by using the obtained prompt and the image generative AI. Note that the image generative AI may be configured to be included in the poster creation application. Alternatively, the configuration may be such that the poster creation application includes no image generative AI, and uses an external image generative AI service via the data communication unit 108. The image generation component 2502 outputs the generated image to the image designation component 203.

### <Examples of Display Screens>

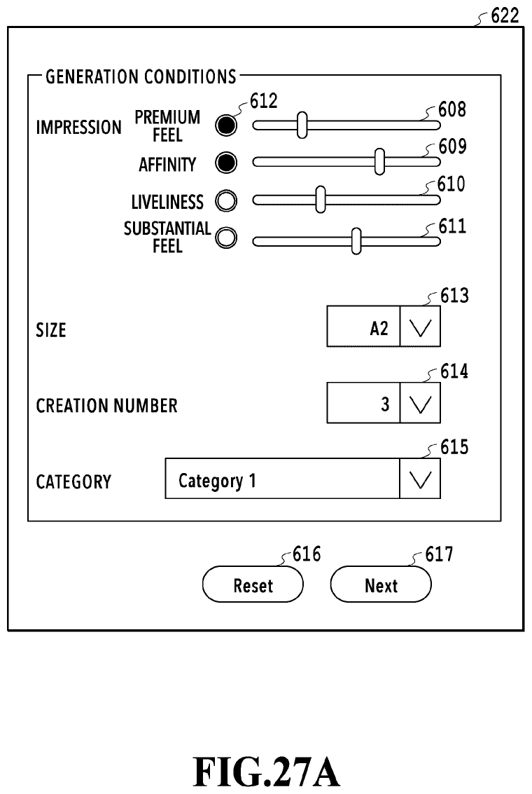

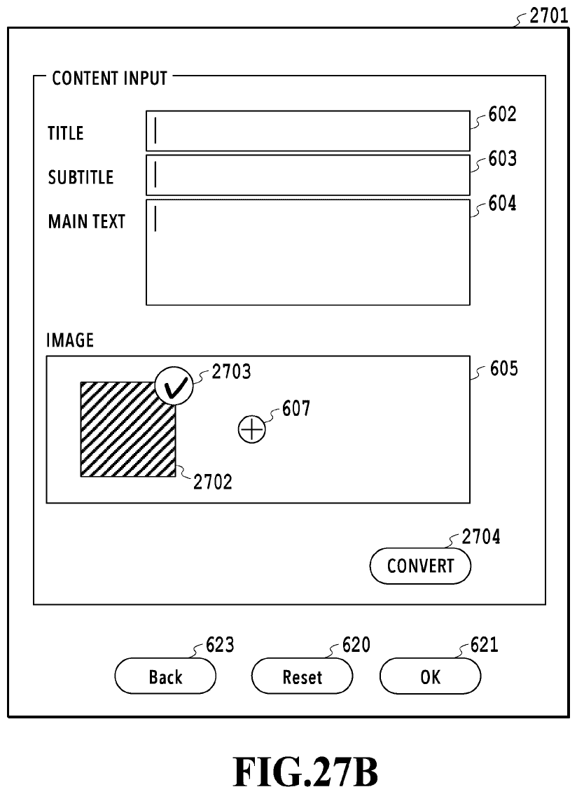

FIGS. 27A to 29 are examples of screens displayed in the poster creation application of the second embodiment. FIG. 27A illustrates the generation condition setting screen 622, and FIG. 27B is a diagram illustrating an example of a content setting screen 2701. Since configurations in FIGS. 27A and 27B denoted by the same reference numerals as those in FIGS. 6A and 6B are the same as those in the first embodiment, explanation thereof is omitted. The screens in FIGS. 27A and 27B are different from the screens in FIGS. 6A and 6B in that a conversion button 2704 is provided. A thumbnail of an image 2702 displayed in the image designation region 605 is set to a selected state in the case where the user performs a designation operation, and a check mark 2703 is displayed. The conversion button 2704 is a button operated to execute an image conversion process on the image 2702 in the selected state to which the check mark 2703 is put. In the case where the user presses the conversion button 2704, the image conversion process illustrated in FIGS. 31A to 31D is executed. The image conversion process is described later.

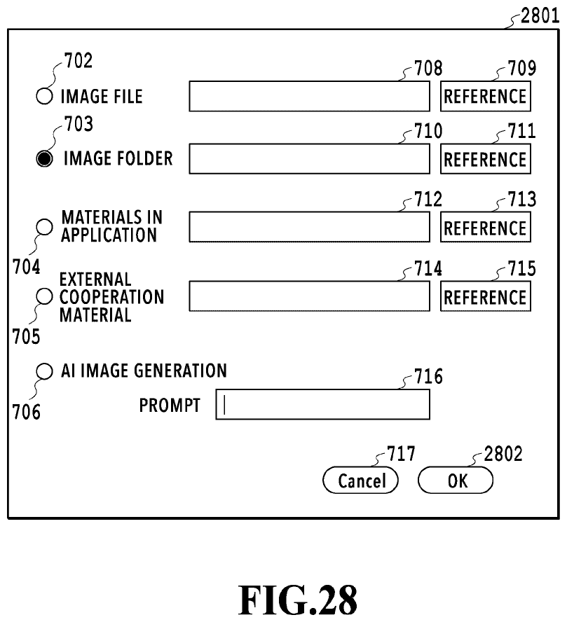

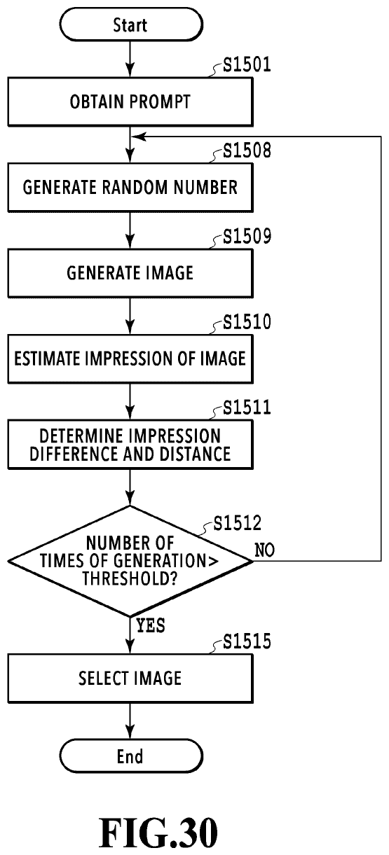

FIG. 28 is a diagram illustrating an example of the image designation screen 2801. Since configurations in FIG. 28 that are denoted by the same reference numerals as those in FIG. 7 are the same as those in the image designation screen 701 (FIG. 7) of the first embodiment, explanation thereof is omitted. The image designation screen 2801 is different from the image designation screen 701 of the first embodiment in that the check box 719 for setting the prompt change permission information is omitted. Moreover, contents of processes executed in the case where an OK button 2802 is pressed are different from those in the first embodiment. In the second embodiment, in the case where the user presses the OK button 2802, the screen displayed on the display 105 transitions to the content setting screen 2701. In this case, a thumbnail of each of one or multiple images 2702 designated in the image designation screen 2801 is added to the image designation region 605. Note that, in the case where the OK button 2802 is pressed in a state where the radio button 706 indicating AI image generation on the image designation screen 2801 is on, an image generation process illustrated in FIG. 30 is executed, and then the screen transitions to the content setting screen 2701.

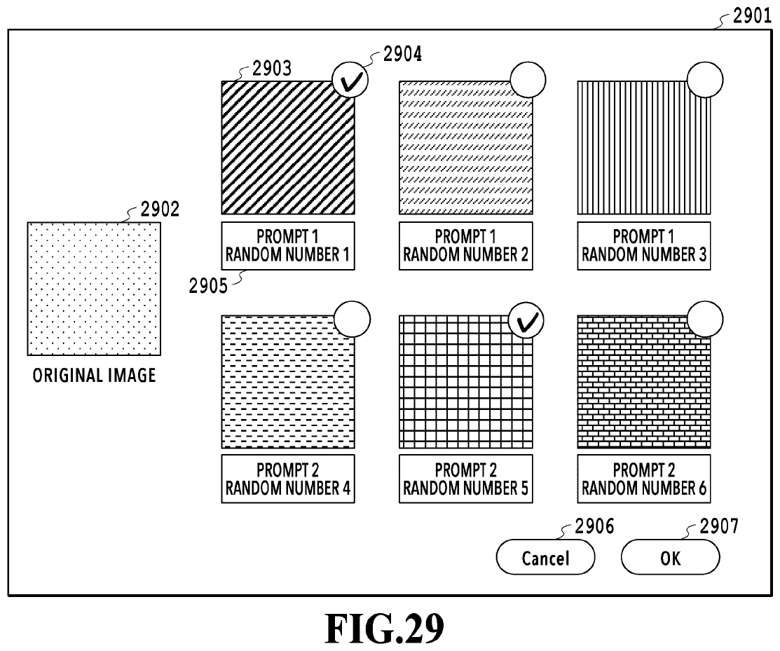

FIG. 29 is a diagram illustrating an example of an image selection screen 2901. The image selection screen 2901 is a screen in which the images converted by the image conversion component 2501 are displayed, and is displayed on the display 105. The screen displayed on the display 105 transitions to the image selection screen 2901 in the case where the conversion button 2704 on the content setting screen 2701 is pressed and the image conversion is completed.

An original image 2902 and one or multiple converted images 2903 are displayed on the image selection screen 2901. The original image 2902 is the image 2702 in the selected state in the case where the conversion button 2704 is pressed on the content setting screen 2701. Specifically, the original image 2902 is the image before the image conversion. The converted images 2903 are images generated by the image conversion component 2501. Since one or multiple converted images are generated in the image conversion component 2501, one or multiple converted images 2903 are displayed on the image selection screen 2901 as a list. The user performs a designation operation on one of the converted images 2903 by using the pointing device 107 or the like. The designated converted image 2903 is thereby set to a selected state, and a check mark 2904 is displayed. Note that multiple converted images 2903 may be selectable.

An information display area 2905 is displayed near each converted image 2903. Information on the image conversion is displayed in the information display area 2905. In the present embodiment, the prompt and the random number used in the conversion of the corresponding converted image 2903 are displayed as the information on the image conversion. A cancel button 2906 is a button for cancelling the selection of the converted image. In the case where the cancel button 2906 is pressed, the selection of the converted image is cancelled, and the screen displayed on the display 105 transitions to the content setting screen 2701. In the case where the user presses an OK button 2907, the poster creation application saves the selected converted image 2903 in the HDD 104, and the screen displayed on the display 105 transitions to the content setting screen 2701. Moreover, a thumbnail of the converted image 2903 in the selected state at the time point of pressing of the OK button 2907 is additionally displayed in the image designation region 605 of the content setting screen 2701. Note that the image 2702 in the selected state before the execution of the image conversion process on the content setting screen 2701 may be replaced by the converted image 2903 selected on the image selection screen 2901.

### <Flow of Process>

Since a flow of a poster generation process executed by the poster creation application of the second embodiment is the same as the poster generation process of the first embodiment illustrated in FIGS. 14A and 14B, explanation thereof is omitted. In this section, the image generation process and the image conversion process executed in the second embodiment are explained.

First, the image generation process executed in the second embodiment is explained by using FIG. 30. The image generation process is executed in the case where the OK button 2802 is pressed in the state where the radio button 706 for selecting the AI image generation on the image designation screen 2801 is set to ON. As described above, the screen transitions to the image designation screen 2801 in the case where the image addition button 607 is pressed on the content setting screen 2701 displayed in S1403 of the poster generation process.

FIG. 30 is a flowchart explaining the image generation process of the second embodiment in detail. Note that, since processes in FIG. 30 denoted by the same reference numerals as those in FIG. 15 are the same as those in the first embodiment, explanation thereof is omitted. In the flowchart of FIGS. 30, S1502 to S1507 and S1513 to S1514 illustrated in FIG. 15 are omitted. Specifically, in the second embodiment, an image generation process in which the processes relating to the prompt change are omitted is executed. Multiple images are generated for the prompt designated by the user, and an image whose estimated impression is close to the target impression among the generated images is selected by this image generation process.

Next, the image conversion process executed by the image conversion component 2501 is explained in detail with reference to FIGS. 31A to 31D. FIG. 31A is a flowchart explaining the image conversion process executed in the poster generation process of the second embodiment in detail. The image conversion process illustrated in FIG. 31A is executed in the case where the conversion button 2704 is pressed in the state where the image 2702 is selected on the content setting screen 2701 displayed in S1403. Note that, since processes in the flowchart of FIG. 31A denoted by the same reference numerals as those in FIG. 15 are the same as those in the image generation process (FIG. 15) of the first embodiment, explanation thereof is omitted. The image conversion process is executed by the image obtaining component 2601, the prompt obtaining component 2602, the impression estimation component 302, the evaluation component 303, the change component 304, and the generation component 2603 of the image conversion component 2501.

In S3101, the image obtaining component 2601 obtains the image 2702 selected in the image designation region 605 on the content setting screen 2701.

In S3102, the prompt obtaining component 2602 obtains a prompt to be a base in conversion of the image obtained in S3101. Moreover, the prompt obtaining component 2602 stores the obtained prompt in the RAM 103. In the present embodiment, the prompt obtaining component 2602 obtains the prompt based on the impression of the image, according to the flowchart illustrated in FIG. 31B.

### <Prompt Obtaining Process>

The prompt obtaining process in S3102 is explained. FIGS. 31B, 31C, and 31D are flowcharts explaining the prompt obtaining process executed in S3102 in detail. Note that the prompt obtaining process illustrated in FIG. 31B is assumed to be executed as an example in the present embodiment.

### (Prompt Obtaining Process (1))

In S3110 in the prompt obtaining process illustrated in FIG. 31B, the impression estimation component 302 estimates the impression of the image obtained in S3101, and associates the estimated impression with the corresponding image (obtained image). In S3111, the evaluation component 303 determines a difference (impression difference) between the target impression obtained in S1402 and the impression of the image estimated in S3110, and associates the difference with the corresponding image. The determined impression difference represents a change amount necessary for changing the impression of the obtained image to the target impression. In S3112, the prompt obtaining component 2602 obtains a character string (word or multiple words) stored as the additional prompt in the prompt impression table 1600 illustrated in FIG. 16, as the prompt to be the base, based on the impression difference determined in S3111. The prompt obtaining component 2602 determines a distance between the referred impression difference and each of the impressions of the prompts illustrated in the prompt impression table 1600. Then, the prompt obtaining component 2602 obtains top N prompts in ascending order of the determined distance. In the present embodiment, the prompt obtaining component 2602 obtains top two prompts. In this case, a setting method of N may be a fixed value or may be such that a box for designating the number of prompts to be obtained is prepared on the content setting screen 2701, and the prompts are obtained as many as the designated number (not illustrated). Note that, although the prompt is obtained based on the distance between the referred impression difference and each of the impressions of the prompts in the present embodiment, the present disclosure is not limited to this. For example, the prompt obtaining component 2602 may obtain the prompt based on the distance between the target impression and each of the impressions of the prompts.

The obtaining method of the prompt is not limited to the prompt obtaining process (1) described above. For example, the prompt obtaining component 2602 may receive designation of the prompt from the user according to the flowchart illustrated in FIG. 31C.

### (Prompt Obtaining Process (2))

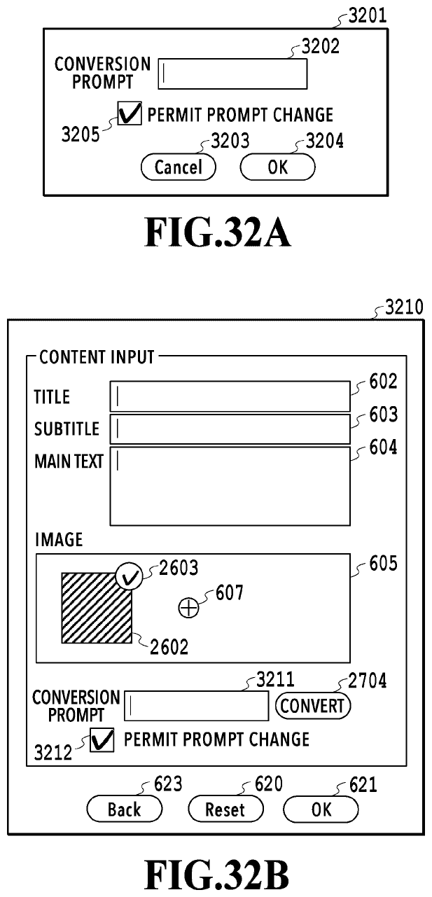

In S3121 in the prompt obtaining process illustrated in FIG. 31C, the prompt obtaining component 2602 displays a prompt input screen 3201 illustrated in FIG. 32A on the display 105. A prompt box 3202 receives designation, by the user, of the prompt to be used for the image conversion. A cancel button 3203 is a button for cancelling the designation of the prompt. In the case where the cancel button 3203 is pressed, the image conversion process illustrated in FIG. 31A is cancelled, and the screen displayed on the display 105 transitions to the content setting screen 2701. In the case where the user presses an OK button 3204 on the prompt input screen 3201, the prompt designated in the prompt box 3202 is outputted to the prompt obtaining component 2602.

Moreover, in S3121, instead of the prompt input screen 3201 illustrated in FIG. 32A, a content setting screen 3210 including a prompt box 3211 as illustrated in FIG. 32B may be displayed on the display 105. In this case, in the case where the conversion button 2704 on the content setting screen 3210 is pressed, a prompt designated in the prompt box 3211 is also outputted to the image conversion component 2501.

Note that the prompt input screen 3201 of FIG. 32A or the content setting screen 3210 of FIG. 32B may be provided with a check box 3205 or 3212 that allows the user to set the prompt change permission information, as in the first embodiment. The image conversion component 2501 may perform control such that the prompt change process of S1506 is not performed in the case where the prompt change permission information is set to off.

In S3122, the prompt obtaining component 2602 obtains the prompt that is inputted through the prompt input screen 3201 or the content setting screen 3210 in S3121 and that is outputted to the image conversion component 2501.

### (Prompt Obtaining Process (3))

Moreover, the prompt obtaining component 2602 may generate and obtain the prompt to be the base from the image obtained by the image obtaining component 2601 in S3101, according to the flowchart illustrated in FIG. 31D. In S3131 in the flowchart illustrated in FIG. 31D, the prompt obtaining component 2602 generates, from the image obtained by the image obtaining component 2601 in S3101, an explanation text (caption) of the obtained image, and outputs the caption. Note that, for example, a publicly-known technique such as a method referred to as contrastive language-image pre-training (CLIP) may be used as a technique of generating the caption from the image. In S3132, the prompt obtaining component 2602 performs morphological analysis on the caption generated in S3131, and obtains an adjective included in the caption as a prompt. Note that, in the case where the caption includes no adjective, the obtained prompt is handled as null. In this case, the estimated impression of the prompt obtained in S1503 of FIG. 31A are assumed to be 0 for all factors, and the process is continued. That is the explanation of the prompt obtaining process in S3102 of FIG. 31A. The description returns to FIG. 31A.

The image designated by the user are obtained, and the prompt for converting the obtained image is obtained by the processes of S3101 to S3102. Next, in S1503, the impression estimation component 302 estimates the impression of the obtained prompt, and in S1504, the evaluation component 303 determines the difference (impression difference) and the distance between the target impression obtained in S1402 and the impression of the prompt estimated in S1503. The determined impression difference is used as the change amount for changing the impression of the prompt to the target impression.

In S1505, the evaluation component 303 determines whether the distance determined in S1504 is larger than the predetermined threshold. In the case where the distance determined in S1504 larger than the threshold, the evaluation component 303 causes the process to transition to S1506. In the case where the distance is not larger than the threshold, S1506 and S1507 are skipped, and the process transitions to S1508.

In S1506, the change component 304 changes the prompt obtained in S3102 to the prompt suiting the target impression. The prompt change process in S1506 is the same as that in the first embodiment, and a series of prompts may be determined by, for example, adding, to the base prompt being a main prompt, one or multiple additional prompts modifying the base prompt. As in the first embodiment, one of the modes of the base prompt determination method and one of the modes of the prompt change method may be used. In S1507, the change component 304 selects the prompt to be used for the style conversion, from the prompt before the change and the changed prompt. In the present embodiment, as in the first embodiment, it is assumed that the prompt selection screen 810 illustrated in FIG. 8A is displayed on the display 105, and the prompt selection by the user is received. Note that the configuration may such that the change component 304 selects the changed prompt and performs the subsequent process without the display of the prompt selection screen. In S1508, the generation component 2603 generates the initial value (random number) to be inputted into the image generative AI.

Next, the process proceeds to S3103. In S3103, the generation component 2603 inputs the prompt obtained in S3102 or the prompt selected in S1507 and the random number generated in S1508 into the image generative AI, and performs style conversion of an image to generate a new image. In this case, the style conversion is a technique of converting an image style (style) of an inputted image to a style to which the image is desired to be converted by the user. Methods of the style conversion includes a method of designating a prompt roughly representing the style to which the image is desired to be converted and a method of designating an image representing the style to which the image is desired to be converted. In the present embodiment, the method of designating a prompt representing the style to which the image is desired to be converted is used. Note that a known technique may be used for the style conversion, and detailed explanation of the style conversion of the image is omitted.

In the case where there are multiple obtained prompts, the generation component 2603 performs the style conversion of the image by using each prompt, and obtains multiple converted images. Moreover, the generation component 2603 counts the number of times the converted image is generated with the random number changed, and records the number in the RAM 103. Note that, in the case where S1506 and S1507 of FIG. 31A are performed and then the style conversion using the changed prompt is performed, the generation component 2603 resets the count of the number of times of generation, and then performs the counting again. Moreover, the generation component 2603 may associate the generated converted image with information on the original image, the prompt, and the random number used in the generation of this converted image.

After S3103, the process proceeds to S1510. In S1510, the impression estimation component 302 estimates the impression of each of one or multiple converted images generated by the generation component 2603 in S3103, and holds the estimated impression in association with the corresponding converted image.

In S1511, the evaluation component 303 determines the difference (impression difference) and the distance between the target impression obtained in S1402 and each of the estimated impressions of the converted images estimated in S1510, and holds the difference and the distance in association with the converted image. The determined impression difference expresses a change amount necessary for changing the impression of the converted image to an impression close to the target impression. Moreover, the smaller the value of the distance is, the closer the impression of the converted image is to the target impression.

In S1512, the evaluation component 303 obtains the number of times of conversion of the image stored in the RAM 103, and determines whether the number of times of conversion is larger than a predetermined threshold (number of times of conversion set as the upper limit). In the case where the obtained number of times of conversion is larger than the threshold, the evaluation component 303 causes the process to transition to S1514. In the case where the obtained number is not larger than the threshold, the evaluation component 303 causes the process to transition to S1508. In the present embodiment, the evaluation component 303 sets the upper limit (threshold) of the number of times of conversion to five. Note that the threshold may be any number equal to or more than one. The larger the threshold is, the more the obtained image generation results are, and the smaller the threshold is, the fewer the obtained style converted images are, but processing time can be reduced.

In S1514, the evaluation component 303 determines whether all distances (distance between the target impression and each of the impressions of the converted images) determined in S1511 are larger than a predetermined threshold or not. In the case where all distances determined in S1511 are larger than the threshold (S1514; YES), the evaluation component 303 causes the process to transition to S1506. In the case where there is at least one converted image for which the distance determined in S1511 is equal to or smaller than the threshold (S1514; NO), the evaluation component 303 causes the process to transition to S3104. Note that, in the case where the evaluation component 303 determines that the number of times of image conversion exceeds the certain number in the determination of S1512 and all distances determined in S1511 are larger than the threshold in the determination of S1514, the evaluation component 303 may perform an operation such as notification to the user. This case means that no image close to the target impression is generated even in the case where the style of the image is changed multiple times. Accordingly, the evaluation component 303 may display a warning screen indicating that prompt change suiting the target impression is difficult, on the display 105, and then cancel the image conversion process illustrated in FIG. 31A. Alternatively, the evaluation component 303 may obtain and hold top N converted images in ascending order of the distance determined in S1511 up to this time point, and transition to S3104.

In S3104, the generation component 2603 selects an image to be actually used in the poster, from the converted images. In the second embodiment, the generation component 2603 displays the image selection screen 2901 on the display 105, and displays the converted images for which the distance determined in S1511 is determined to be equal to or smaller than the predetermined threshold, as the converted images 2903 of the image selection screen 2901. Then, image selection by the user is received. In the present embodiment, the generation component 2603 displays all converted images on the image selection screen 2901 in ascending order of the distance associated with each converted image. Note that the display order and the number of images displayed are not limited to these. For example, the generation component 2603 may select a predetermined number of converted images in ascending order of the distance associated with each converted image, and display the selected converted images on the image selection screen 2901. In this case, a box for designating the number of converted images may be prepared on the content setting screen 2701, and the converted images as many as the number designed by the user are selected (not illustrated). Moreover, the generation component 305 may display the converted images in random order on the image selection screen 2901 without referring to the distances associated with the converted images.

The image selected on the image selection screen 2901 is used in the poster generation, as the content to be arranged in the poster.

As explained above, according to the second embodiment, a prompt for converting an image to a style close to the target impression is determined based on the image designated by the user or the image generated by the generative AI, and one or multiple converted images are generated. Moreover, in the case where multiple converted images are generated, an image to be used in the poster can be selected from among the generated converted images. An image is thereby converted to a style close to the target impression in the poster creation application that generates data of a creation product such as a poster. Accordingly, obtaining of a content to be arranged in the creation product is facilitated, and usability is improved. Moreover, generation of a poster close to the target impression is facilitated.

### <<Modified Example of Second Embodiment>>

In the above-mentioned second embodiment, the prompt used for the style conversion of an image is obtained based on the target impression and the image designated by the user, and is changed to become close to the target impression, and then the style of the image is converted. However, the present disclosure is not limited to this process, and the prompt obtained in the prompt obtaining process of S3102 may be used not for the style conversion of an image but for generation of an image. In a modified example of the second embodiment, explanation is given of an example in which the poster creation application generates a prompt from an obtained image, changes the prompt as necessary, and then generates an image by using the image generative AI.

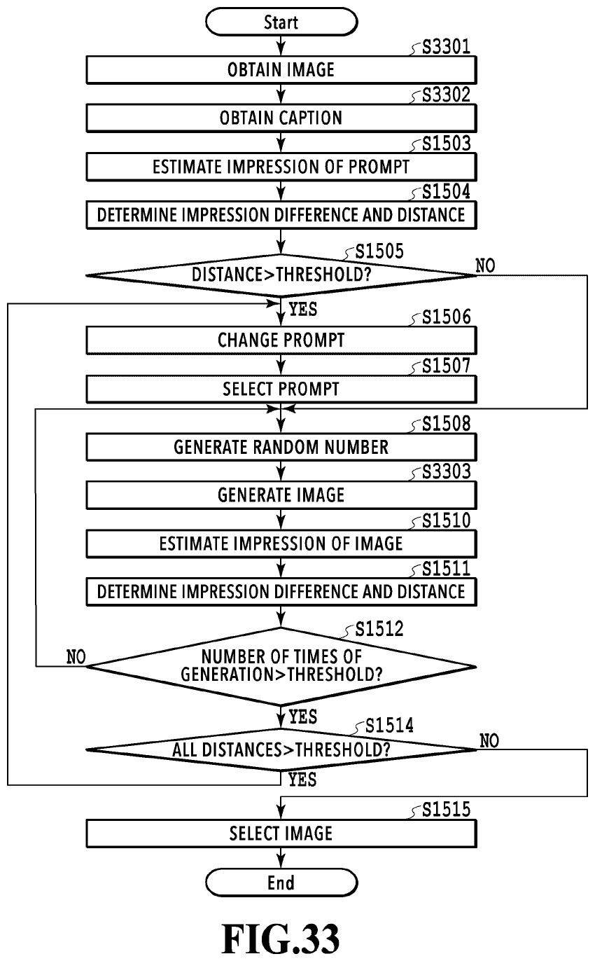

FIG. 33 is a flowchart explaining an image conversion process in the modified example of the second embodiment in detail. Note that, since processes in the present flowchart denoted by the same reference numerals as those in the flowchart of FIGS. 31A and 31B are the same as the processes explained in the second embodiment, explanation thereof is omitted. Note that the image conversion process illustrated in FIG. 33 is executed in the case where the conversion button 2704 is pressed in the state where the image 2702 is selected on the content setting screen 2701 displayed in S1403.

In S3301, as in S3101 in the image conversion process of the second embodiment, the image obtaining component 2601 obtains the image 2702 selected in the image designation region 605 on the content setting screen 2701.

Next, the process proceeds to S3302. In S3302, the prompt obtaining component 2602 generates a caption of the image obtained in S3301. As described above, any publicly-known method may be used for the process of generating the caption from the image. The prompt obtaining component 2602 obtains the generated caption as a prompt. Moreover, the prompt obtaining component 2602 stores the obtained prompt in the RAM 103.

Then, the processes of S1503 to S1508 are executed as in the first and second embodiments. Specifically, the poster creation application determines an impression difference and a distance between the target impression and the impression of the prompt obtained in S3302, and in the case where a value of the distance is larger than a predetermined threshold, changes the prompt to a prompt close to the target impression, based on the impression difference. Moreover, the poster creation application selects a prompt to be used in the image generation from the changed prompts, and generates a random number to be inputted into the image generative AI. Next, the process proceeds to S3303.

In S3303, the generation component 2603 inputs the prompt obtained in S3302 or S1507 and the random number generated in S1508 into the image generative AI, and generates an image. A Stable Diffusion model, a GAN model, Midjourney, or the like may be used as the image generative AI as described above.

Then, the processes of S1510 to S1515 are executed as in the first and second embodiments. Specifically, an impression difference and a distance between the target impression and the impression of the image generated in S3303 are determined, and associated with the generated image, and the image generation is repeated until the number of times of generation reaches a predetermined threshold (upper limit number). In the case where the number of times of generation exceeds the upper limit number and the values of the distances determined in S1511 for all generated images are larger than a predetermined threshold, the prompt change and the image generation are further repeated. In the case where an image for which the value of the distance determined in S1511 is equal to or smaller than the predetermined threshold is generated at a stage where the number of times of image generation exceeds the upper limit number, the process transitions to S1515, the image selection screen 2901 is displayed on the display 105, and one or multiple generated images are presented to the user. The configuration may be such that, in the case where no image for which the value of the distance is equal to or smaller than the predetermined threshold is generated at the stage where the number of times of image generation exceeds the upper limit number, a warning screen is displayed, and the present flowchart is terminated.

As explained above, according to the modified example of the second embodiment, a caption is generated from the image designated by the user and is used as the prompt, the prompt is changed to a prompt by which an image suiting the target impression can be generated, and then an image is generated by using the image generative AI. A new image suiting the target impression can be thereby generated while taking contents of the image designated by the user into consideration. Accordingly, it is possible propose, to the user, a new image that takes the intention of the user into consideration but is not bounded too much to the inputted image, and usability of obtaining an intended content can be improved.

### Third Embodiment

In the first and second embodiments, explanation is given of the process in which the prompt for generating or converting an image is determined based on the impression of the prompt or the impression of the image generated based on the prompt. In a third embodiment, explanation is given of an example in which the prompt change process is executed based on an impression of a poster generated by the poster generation application. The prompt change process can be thereby performed while focusing on an impression of the poster that is a creation product to be eventually obtained. Accordingly, generation of a poster closer to an intended design can be facilitated.

### <Software Block Diagram>

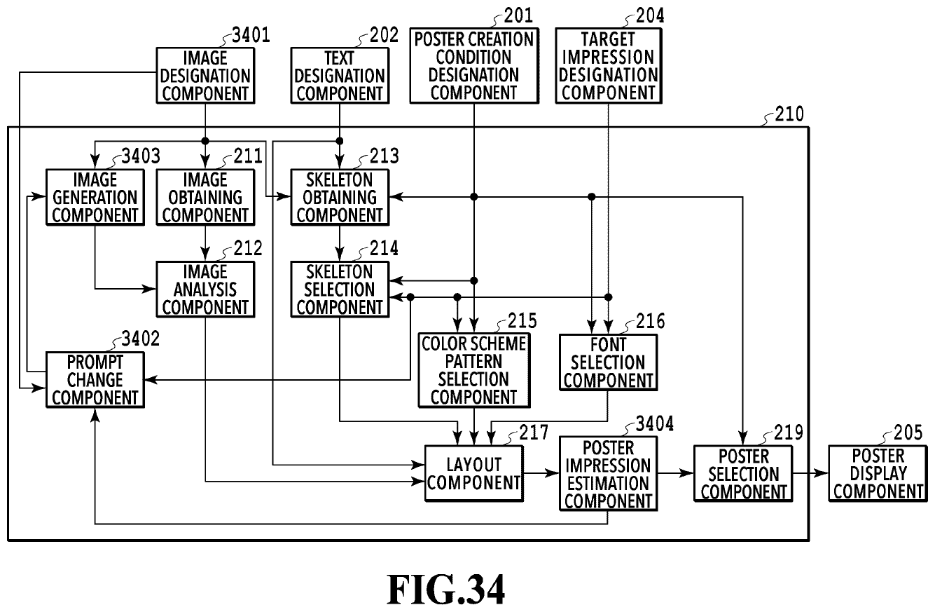

FIG. 34 is a software block diagram of the poster creation application in the third embodiment. As illustrated in FIG. 34, the poster creation application includes the poster creation condition designation component 201, the text designation component 202, an image designation component 3401, the target impression designation component 204, the poster display component 205, and the poster generation component 210. The poster generation component 210 includes a prompt change component 3402, an image generation component 3403, the image obtaining component 211, the image analysis component 212, the skeleton obtaining component 213, the skeleton selection component 214, the color scheme pattern selection component 215, the font selection component 216, the layout component 217, a poster impression estimation component 3404, and the poster selection component 219. The poster creation application is different from that of the first embodiment (FIG. 2) in that the prompt change component 3402 and the image generation component 3403 are added. Moreover, processing contents of the image designation component 3401 and the poster impression estimation component 3404 are different from those of the image designation component 203 and the poster impression estimation component 218 in the first embodiment. Note that, since configurations denoted by the same reference numerals as those in FIG. 2 are the same as the configurations in the first embodiment, explanation thereof is omitted.

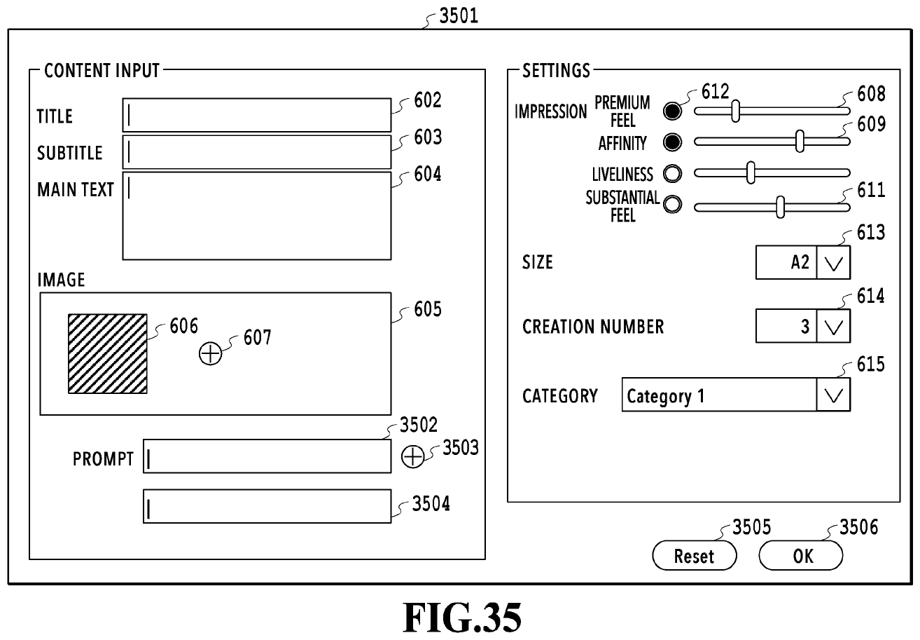

The image designation component 3401 receives designation, by the user, of one or multiple pieces of image data to be arranged in the poster as in the first embodiment. Moreover, a prompt designated in a setting screen 3501 (FIG. 35) to be described later is outputted to the image generation component 3403. Furthermore, the image designation component 3401 outputs, to the skeleton obtaining component 213, a sum of the number of designated images and the number of designated prompts, as the number of images to be used.

The image generation component 3403 generates an image to be used in the poster by using the image generative AI and the prompt obtained from the image designation component 3401 or the prompt change component 3402. Note that the image generative AI may be configured to be included in the poster creation application. Moreover, the configuration may be such that the poster creation application includes no image generative AI, and uses an external image generative AI service via the data communication unit 108. The image generation component 3403 outputs the generated image to the image analysis component 212.

The poster impression estimation component 3404 estimates the impression of each of the multiple pieces of poster data obtained from the layout component 217, and associates the estimated impression with the piece of poster data as in the first embodiment. Then, the poster impression estimation component 3404 outputs one or multiple pieces of poster data associated with the estimated impression, to the poster selection component 219. Moreover, in the third embodiment, the poster impression estimation component 3404 outputs the poster data associated with the estimated impression to the prompt change component 3402.

The prompt change component 3402 obtains the designated prompt from the image designation component 3401, and obtains the target impression from the target impression designation component 204. Moreover, the prompt change component 3402 obtains the poster data associated with the estimated impression of the poster and the prompt used in the image generation, from the poster impression estimation component 3404. Then, the prompt change component 3402 changes the obtained prompt such that the estimated impression of the poster becomes close to the target impression, and outputs the prompt to the image generation component 3403.

### <Example of Input Screen>

FIG. 35 is a diagram illustrating an example of the setting screen 3501 displayed on the display 105 in the poster generation process of the third embodiment. The setting screen 3501 is a screen in which the generation condition setting screen 622 and the content setting screen 601 explained in the first embodiment are integrated into one screen. Since configurations denoted by the same reference numerals as those in FIGS. 6A and 6B are the same as the configurations in the first embodiment, explanation thereof is omitted.

A prompt box 3502 is a box for receiving designation, by the user, of a prompt to be used as input of the image generative AI. The image designation component 3401 outputs the prompt inputted in the prompt box 3502, to the prompt change component 3402.

A prompt addition button 3503 is a button pressed in the case where an additional prompt box 3504 is desired to be displayed. The additional prompt box 3504 receives designation of a prompt by the user like the prompt box 3502. The user can designate multiple prompts by inputting prompts into the prompt box 3502 and the additional prompt box 3504. Note that a method of designating multiple prompts is not limited to this. For example, the configuration may be such that character information inputted into one prompt box 3502 is divided at a line feed character, and multiple pieces of divided character information are handled as separate prompts.

A reset button 3505 is a button for resetting pieces of setting information on the setting screen 3501. In the case where the user presses an OK button 3506, the poster creation condition designation component 201, the text designation component 202, the image designation component 3401, and the target impression designation component 204 output the contents set on the setting screen 3501 to the poster generation component 210. In this case, the poster creation condition designation component 201 obtains the size of the poster to be created from the size list box 613, obtains the number of posters to be created from the creation number box 614, and obtains the use application category of the poster to be created from the category list box 615. The text designation component 202 obtains the character information to be arranged in the poster from the title box 602, the subtitle box 603, and the main text box 604. The image designation component 3401 obtains the file path of the image to be arranged in the poster from the image designation region 605. The target impression designation component 204 obtains the target impression of the poster to be created from the impression sliders 608 to 611 and the radio buttons 612. Note that the poster creation condition designation component 201, the text designation component 202, the image designation component 3401, and the target impression designation component 204 may process the values set on the setting screen 3501 as in the first embodiment.

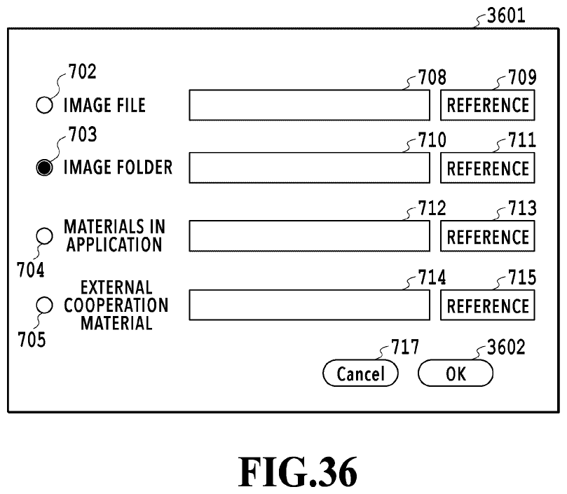

FIG. 36 is a diagram illustrating an example of an image designation screen 3601 in the third embodiment. Since configurations denoted by the same reference numerals as those in the image designation screen 701 of FIG. 7 are the same as those in the first embodiment, explanation thereof is omitted. In the image designation screen 3601, the radio button 706 and the prompt box 716 for designating the AI image generation and the check box 719 for switching on/off of the prompt change permission information are excluded from the image designation screen 701 of the first embodiment.

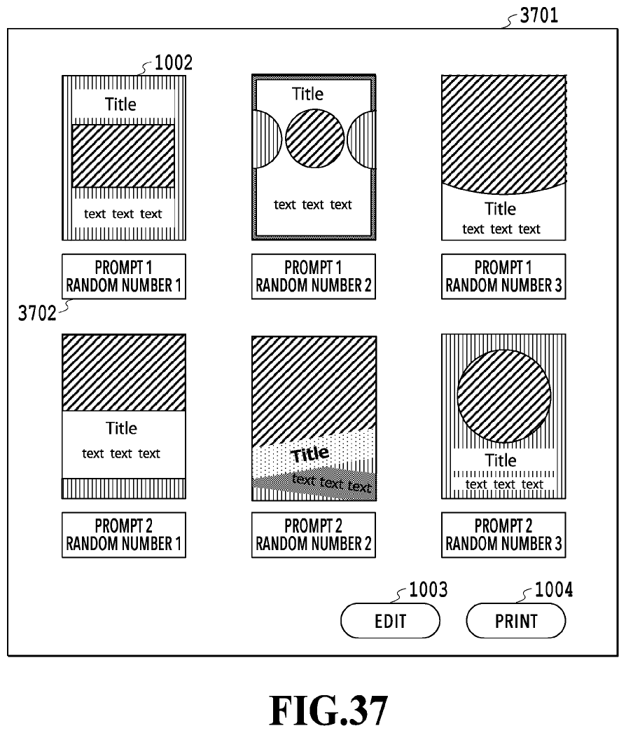

FIG. 37 is a diagram illustrating an example of a poster preview screen 3701 in the third embodiment. Since configurations denoted by the same reference numerals as those in the poster preview screen 1001 of FIG. 10 are the same as those in the first embodiment, explanation thereof is omitted. Information display areas 3702 are provided on the poster preview screen 3701 of the third embodiment. The information display areas 3702 are each an area in which information on the image generation is displayed. In the present embodiment, the prompt and the random number used in the generation of the generated image arranged in the corresponding poster are displayed as the information on the image generation.

### <Flow of Process>

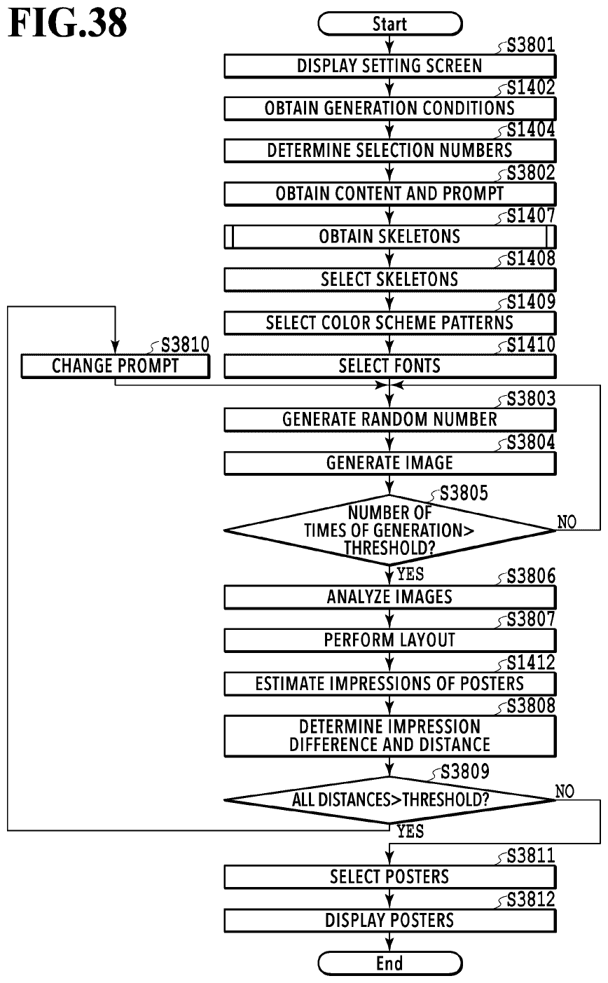

FIG. 38 is a flowchart illustrating the poster generation process executed by the poster creation application in the third embodiment. Note that processes in the present flowchart that are the same as the processes in the poster generation process of the first embodiment illustrated in FIG. 14A are denoted by the same reference numerals, and overlapping explanation is omitted. Differences from the first embodiment are mainly explained below.

In S3801, the poster creation application displays the setting screen 3501 illustrated in FIG. 35 on the display 105. The user inputs settings through a UI screen of the setting screen 3501 by using the keyboard 106 and the pointing device 107.

In S1402, the poster creation condition designation component 201 and the target impression designation component 204 obtain settings corresponding to these components, from the setting screen 3501 as in the first embodiment. Specifically, the poster creation condition designation component 201 obtains the size, the creation number, and the use application category of the poster designated by the user. The target impression designation component 204 obtains the target impression designated by the user.

Next, the process proceeds to S1404. In S1404, the selection numbers are determined such that posters corresponding to the creation number designated in the poster creation condition designation component 201 can be generated as in the first embodiment. Specifically, the skeleton selection component 214 determines the number of skeletons to be selected, the color scheme pattern selection component 215 determines the number of color scheme patterns to be selected, and the font selection component 216 determines the number of fonts to be selected. A determination method of the selection numbers is the same as that in the first embodiment.

Next, the process proceeds to S3802. In S3802, the text designation component 202 and the image designation component 3401 obtain settings corresponding to these components, from the setting screen 3501. Moreover, the image obtaining component 211 obtains image data. Specifically, the image obtaining component 211 reads out the image file in the HDD 104, the materials in the application, or the external cooperation materials designated in the image designation component 3401, to the RAM 103. Furthermore, the image designation component 3401 obtains the prompts designated in the prompt boxes 3502 and 3504 of the setting screen 3501, and holds the prompts in the RAM 103.

Then, the process proceeds to S1407. In S1407, the skeleton obtaining component 213 obtains the skeletons matching various setting conditions. A skeleton obtaining method is the same as that in the first embodiment. S1408 to S1410 are the same as those in the first embodiment. Specifically, the skeleton selection component 214 selects the skeletons matching the target impression designated in the target impression designation component 204 among the skeletons obtained in S1407. In S1409, the color scheme pattern selection component 215 selects the color scheme patterns matching the target impression designated in the target impression designation component 204. In S1410, the font selection component 216 selects combinations of fonts matching the target impression designated in the target impression designation component 204.

Then, the process proceeds to S3803. In S3803, the image generation component 3403 generates a random number as the initial value to be inputted in the image generative AI.

In S3804, the image generation component 3403 inputs the prompt obtained in S3802 or the changed prompt obtained in S3810 and the random number generated in S3803 into the image generative AI, and generates an image. Note that the image generative AI only needs to use a known technique for generating an image from a prompt as in the image generation process of the first embodiment, and detailed explanation of the image generative AI is omitted. For example, Stable Diffusion is used as the image generative AI. Note that, in the case where there are multiple obtained prompts, the image generation is performed for each prompt, and multiple generated images are obtained. Moreover, the image generation component 3403 counts the number of times of image generation, and stores the number in the RAM 103. Note that, in the case where a new random number is generated by S3802 or in the case where the prompt is changed by S3810, the image generation component 3403 resets the count of the number of times of generation, and then performs the counting again. Moreover, the image generation component 3403 associates the generated image with information on the prompt and the random number used for the generation of the generated image.

In S3805, the image generation component 3403 obtains the number of times of generation recorded in the RAM 103, and determines whether the number of times of generation is larger than a predetermined threshold (upper limit number) or not. In the case where the obtained number of times of generation is larger than the threshold (upper limit number), the image generation component 3403 causes the process to transition to S3806. In the case where the number of times of generation does not exceed the predetermined threshold (upper limit number), the image generation component 3403 causes the process to transition to S3803. In the present embodiment, the image generation component 3403 determines whether the number of times of generation is larger than five or not. Note that the threshold (upper limit number) of the number of times of generation may be any number equal to or larger than one.

In S3806, the image analysis component 212 executes an analysis process on the image data obtained in S3802 and the image data generated in S3804, and obtains information indicating feature amounts. Since the analysis process is the same as the process explained in S1406 of the first embodiment, explanation thereof is omitted.

In S3807, the layout component 217 sets the character information, the images, the color schemes, and the fonts for the skeletons selected in the skeleton selection component 214, and generates posters. In a layout process of the third embodiment, the layout component 217 lists combinations of images generated in S3804, combines the combinations with the image obtained in S3802, and lists all combinations of the skeletons, the color scheme patterns, the fonts, and the images. Note that, in the case where there are multiple prompts obtained in S3802, the generated images are selected one by one and combined with each prompt.

For example, assume that there are Generated Image 11 and Generated Image 12 generated, respectively, by using different random numbers on Prompt 1 and Generated Image 21 and Generated Image 22 generated, respectively, by using different random numbers on Prompt 2. In this case, the layout component 217 obtains four patterns of combinations of: Generated Image 11 and Generated Image 21; Generated Image 11 and Generated Image 22; Generated Image 12 and Generated Image 21; and Generated Image 12 and Generated Image 22, as the combinations of images. In the case where Image 3 obtained in S3802 is also present in this situation, Image 3 is combined with each of the four patterns of combinations of Generated Images 11 to 22 to list possible combinations of images. The layout component 217 combines the four patterns of combinations obtained as described above with the skeletons, the color scheme patterns, and the fonts selected in S1408 to S1410.

Note that, although the layout component 217 lists all combinations of the generated images in the present embodiment, the present disclosure is not limited to this. For example, the layout component 217 may display the generated images on the image selection screen 901 (FIG. 9) explained in the first embodiment, and cause the user to designate the generated images to be used. In this case, the combinations of the generated images can be narrowed down to one. Accordingly, the number of combinations with the skeletons, the color scheme patterns, and the fonts can be reduced. The layout component 217 executes the layout process sequentially for the combinations, and generates poster data. The layout process is the same as that in FIG. 21.

Next, the process proceeds to S1412. In S1412, the poster impression estimation component 3404 executes a rendering process on each piece of poster data obtained from the layout component 217, and estimates an impression of a rendered poster image. The poster impression estimation component 3404 associates the estimated impression of the poster with the poster data.

Next, the process proceeds to S3808. In S3808, the poster impression estimation component 3404 determines the difference (impression difference) and the distance between the target impression obtained in S3801 and the impression of the generated poster estimated in S1412, and associates the difference and the distance with the corresponding poster data. The determined impression difference expresses a change amount necessary for bringing the impression of the generated poster close to the target impression. Moreover, the smaller the value of the distance is, the closer the impression of the generated poster is to the target impression.

In S3809, the poster impression estimation component 3404 determines whether all distances determined in S3808 are larger than a predetermined threshold or not. Specifically, in the case where all distances between the target impression and the estimated impressions of the respective posters generated by the layout component 217 are larger than the predetermined threshold, the process transitions to S3810. If not, the process transitions to S3811. Note that, in the case where the number of times of prompt change in S3810 exceeds a certain number and then all distances determined in S3808 are larger than the threshold, the poster creation application may cause the process to transition to a different process such as a user notification process. Specifically, this case means that no poster suiting the target impression is generated even in the case where the prompt is changed multiple times. Accordingly, the poster creation application may display a warning screen indicating that changing to a prompt close to the target impression is difficult, on the display 105, and then cancel the poster generation process. Alternatively, the poster creation application may obtain and hold top N generated posters in ascending order of the value of the distance determined in S3808 up to this stage, and transition to S3811.

In S3810, the prompt change component 3402 changes the prompt obtained in S3802 to a prompt suiting the target impression. The process of the prompt change component 3402 in S3810 is assumed to be the same as the prompt change process in S1506 of the first embodiment. The prompt change component 3402 obtains the additional prompt based on the impression difference determined in S3808.

In S3811, the poster selection component 219 selects a poster to be outputted to the display 105 (to be presented to the user), from the poster data obtained from the poster impression estimation component 3404 . . . . In the present embodiment, the poster selection component 219 selects a poster for which the value of the distance is determined to be equal to or smaller than the threshold in S3809. Other operations are the same as the contents explained in S1513 of the first embodiment.

In S3812, the poster display component 205 renders the poster data selected by the poster selection component 219, and outputs a poster image to the display 105. Specifically, the poster preview screen 3701 illustrated in FIG. 37 is displayed.

As explained above, according to the poster generation process of the third embodiment, the prompt change process can be executed based on the impression of the generated poster. This allows the prompt to be changed while focusing on the impression of the poster that is the final product. Accordingly, generation of a poster closer to an intended design is facilitated. Thus, in the poster creation application that generates data of a creation product such as a poster, it is possible to improve usability of obtaining an intended content to be arranged in the poster.

Although the preferable embodiments according to the present disclosure are explained above with reference to the attached drawings, the present disclosure is not limited to these examples. Although the case where the content to be generated by the generative AI is an image is described in the above-mentioned embodiments, the content is not limited to an image, and may be character information to be arranged in a poster. For example, the present disclosure can be applied to a text or an advertising slogan to be used as a title, a subtitle, or a main text of a poster by using a generative AI capable of generating the text or the advertising slogan. Moreover, for example, although the example in which the prompt for generating an image is changed based on the poster impression is described in the third embodiment, the prompt for performing the style conversion on an image as described in the second embodiment may be determined. Furthermore, a template may be selected and presented instead of the poster generation. Moreover, the display screen, the processing flows, the layout method, and the like are examples. Furthermore, it is apparent that those skilled in the art can come up with various change examples or modification examples within the scope of the disclosed technical idea, and these change examples and modification examples are understood to also belong to the technical scope of the present disclosure as a matter of course.

According to the present disclosure, in the information processing apparatus that generates data of a creation product such as a poster, usability of obtaining a content to be arranged in the creation product is improved.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-115079, filed Jul. 18, 2024, which is hereby incorporated by reference herein in its entirety.

What is claimed is:

1. An information processing apparatus configured to generate data of a creation product, the information processing apparatus comprising:
one or more memories; and
one or more processors storing instructions to cause the one or more processors to function as:
a reception unit configured to receive designation of a target impression by a user, the target impression being an impression that is required to be eventually given by the creation product; and
a determination unit configured to determine a prompt that causes a generative artificial intelligence (AI) to generate a content to be arranged in the creation product, wherein
a first prompt determined by the determination unit in a case where the reception unit receives a first target impression is different from a second prompt determined by the determination unit in a case where the reception unit receives a second target impression different from the first target impression.

2. The information processing apparatus according to claim 1, wherein the determination unit determines the first prompt or the second prompt based on the target impression and an impression estimated from the prompt.

3. The information processing apparatus according to claim 1, wherein the determination unit determines the first prompt or the second prompt based on the target impression and an impression estimated from the content generated by using the prompt.

4. The information processing apparatus according to claim 1, wherein the determination unit determines the first prompt or the second prompt based on the target impression and an impression estimated from the creation product in which the content generated by using the prompt is arranged.

5. The information processing apparatus according to claim 2, wherein
the reception unit further receives designation of a prompt by the user, and
the determination unit determines the first prompt or the second prompt by changing a character string included in the prompt received by the reception unit.

6. The information processing apparatus according to claim 2, wherein
the reception unit further receives designation of the content by the user,
wherein the one or more processors are further configured to function as an obtaining unit configured to obtain a prompt based on the content received by the reception unit, and
the determination unit determines the first prompt or the second prompt by changing a character string included in the prompt obtained by the obtaining unit.

7. The information processing apparatus according to claim 1, wherein
the reception unit further receives designation of the content by the user, and
the determination unit determines a conversion prompt for converting the content received by the reception unit, as the first prompt or the second prompt.

8. The information processing apparatus according to claim 7, wherein
the content is an image, and
the conversion prompt is a prompt for changing an image style of the image.

9. The information processing apparatus according to claim 1, wherein the one or more processors are further configured to function as a selection unit configured to select the prompt for generating the content to be arranged in the creation product, from one or a plurality of the first prompts or the second prompts determined by the determination unit.

10. The information processing apparatus according to claim 9, wherein the selection unit displays a screen that allows the user to select the prompt for generating the content to be arranged in the creation product from the one or a plurality of the first prompts or the second prompts determined by the determination unit, and receives selection by the user.

11. The information processing apparatus according to claim 1, wherein the one or more processors are further configured to function as a selection unit configured to select the content to be arranged in the creation product, from one or a plurality of contents generated by the generative AI by using, respectively, one or a plurality of the first prompts or the second prompts determined by the determination unit.

12. The information processing apparatus according to claim 4, wherein the one or more processors are further configured to function as a selection unit configured to select one or a plurality of pieces of the data of the creation products in which one or a plurality of contents are arranged, the one or a plurality of contents generated by the generative AI by using, respectively, one or a plurality of the first prompts or the second prompts determined by the determination unit.

13. The information processing apparatus according to claim 1, wherein the first prompt and the second prompt vary in an included character string.

14. The information processing apparatus according to claim 1, wherein the prompt determined by the determination unit includes a base prompt that is a prompt to be a base and one or a plurality of additional prompts added to the base prompt, and the first prompt and the second prompt vary in the additional prompt.

15. The information processing apparatus according to claim 14, wherein the determination unit determines the additional prompt based on a difference between the target impression and an impression estimated from the base prompt.

16. The information processing apparatus according to claim 14, wherein, in a case where the reception unit receives designation of the prompt by the user, the determination unit handles the prompt received by the reception unit as the base prompt.

17. The information processing apparatus according to claim 14, wherein, in a case where the reception unit receives designation of the content by the user, the determination unit obtains the base prompt based on an impression estimated from the content received by the reception unit.

18. The information processing apparatus according to claim 1, wherein the creation product is a poster.

19. An information processing method of generating data of a creation product, the information processing method comprising:
receiving designation of a target impression by a user, the target impression being an impression that is required to be eventually given by the creation product; and
determining a prompt that causes a generative AI to generate a content to be arranged in the creation product, wherein
a first prompt determined in the determining in a case where a first target impression is received in the receiving is different from a second prompt determined in the determining in a case where a second target impression different from the first target impression is received in the receiving.

20. A non-transitory computer readable storage medium storing a program which causes one or more processors of a computer to execute an information processing method of generating data of a creation product, the information processing method comprising:
receiving designation of a target impression by a user, the target impression being an impression that is required to be eventually given by the creation product; and
determining a prompt that causes a generative AI to generate a content to be arranged in the creation product, wherein
a first prompt determined in the determining in a case where a first target impression is received in the receiving is different from a second prompt determined in the determining in a case where a second target impression different from the first target impression is received in the receiving.
